(19) United States
(12) Patent Application Publication
(10) Pub. No.: US 2024/0276323 A1
(43) Pub. Date: Aug. 15, 2024

(54) METHOD AND DEVICE USED IN COMMUNICATION NODE FOR WIRELESS COMMUNICATION

(71) Applicants: Qiaoling YU, Shanghai (CN); Xiaobo ZHANG, Shanghai (CN)

(72) Inventors: Qiaoling YU, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/642,860

(22) Filed: Apr. 23, 2024

Related U.S. Application Data
(63) Continuation of application No. PCT/CN2022/125852, filed on Oct. 18, 2022.

(30) Foreign Application Priority Data
Oct. 24, 2021 (CN) 202111236985.4
Nov. 2, 2021 (CN) 202111286519.7
Nov. 21, 2021 (CN) 202111381418.8

(51) Int. Cl. H04W 36/00; H04W 36/08; H04W 36/18; H04W 36/24

(52) U.S. Cl. CPC H04W 36/0079; H04W 36/08; H04W 36/18; H04W 36/249

(57) ABSTRACT

The present application provides a method and a device in a communication node for wireless communications. A communication node receives a first signaling, the first signaling indicates a configuration of a first cell; executes a first handover from a source cell to the first cell which comprises applying the configuration of the first cell; determines first handover failure and executes a first operation; the first operation is a candidate operation in a first candidate operation set which comprises at least two candidate operations of returning to the source cell and executing a second handover; the first operation is related to at least whether the first node is configured with at least one conditional reconfiguration candidate cell; when the first node is not configured with a conditional reconfiguration candidate cell, the first operation is returning to the source cell.

### CROSS REFERENCE TO RELATED APPLICATIONS

The present application is the continuation of the international patent application No. PCT/CN2022/125852, filed on Oct. 18,2022, and claims the priority benefit of Chinese Patent Application No.202111236985.4, filed on Oct. 24,2021; and claims the priority benefit of Chinese Patent Application No.202111286519.7, filed on Nov. 2,2021; and claims the priority benefit of Chinese Patent Application No.202111381418.8, filed on Nov. 21,2021 the full disclosure of which is incorporated herein by reference.

### BACKGROUND

### Technical Field

The present application relates to transmission methods and devices in wireless communication systems, and in particular to a transmission scheme and device for mobility.

### Related Art

To enhance mobility, 3GPP (3rd Generation Partnership Project) Release 16 introduces Conditional Reconfiguration and Dual Active Protocol Stack (DAPS) handover. The conditional reconfiguration comprises CHO (Conditional Handover) and PSCell (Primary SCG (Secondary Cell Group) Cell) change for a PCell (Primary Cell). The DAPS handover supports the simultaneous use of radio resources of a source cell and a target cell during the handover process to shorten the handover delay, and CHO and DAPS cannot be configured at the same time in the current protocol.

### SUMMARY

On the one hand, according to the existing protocols, when Radio Link Failure (RLF) or Handover Failure (HOF) occurs in a UE (User Equipment), cell reselection is performed, and if a CHO candidate cell is selected, the configuration of the CHO candidate cell is applied, thus avoiding an RRC (Radio Resource Control) connection re-establishment. However, if the UE selects a source cell, it needs to perform an RRC connection re-establishment procedure due to the releasing of the RRC configuration of the source cell, therefore, how to avoid RRC connection re-establishment and shorten the transmission delay needs to be further enhanced. On the other hand, when DAPS and CHO are independently configured, when handover failure occurs in the UE, the UE recovers the source cell if DAPS is configured and no RLF occurs in the source cell; when handover failure occurs in the UE, if a CHO candidate cell is configured, the UE executes a cell selection and, if a CHO candidate cell is selected, the configuration of the CHO candidate cell is applied; if both DAPS and CHO are configured, when handover failure occurs in the UE, an optimal design of the UE behavior after the handover failure is required.

To address the above problem, the present application provides a solution. In the description of the above problem, a handover scenario is illustrated as an example; the present application is equally applicable to scenarios such as sidelink (SL) transmission and IAB (Integrated Access and Backhaul) transmission, achieving similar technical results as in the handover scenario. Additionally, the adoption of a unified solution for various scenarios contributes to the reduction of hardware complexity and costs.

In one embodiment, interpretations of the terminology in the present application refer to definitions given in the 3GPP TS38 series.

In one embodiment, interpretations of the terminology in the present application refer to definitions given in the 3GPP TS36 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

It should be noted that if no conflict is incurred, embodiments in any node in the present application and the characteristics of the embodiments are also applicable to any other node, and vice versa. And the embodiments in the present application and the characteristics in the embodiments can be arbitrarily combined if there is no conflict.

The present application provides a method in a first node for wireless communications, comprising:
receiving a first signaling, the first signaling indicating a configuration of a first cell; executing a first handover from a source cell to the first cell; determining first handover failure; and
as a response to the behavior of determining first handover failure, executing a first operation;
herein, the behavior of executing a first handover from a source cell to the first cell comprises applying the configuration of the first cell; the first operation is a candidate operation in a first candidate operation set, and the first candidate operation set comprises at least two candidate operations of returning to the source cell and executing a second handover; the first operation is related to at least whether the first node is configured with at least one conditional reconfiguration candidate cell.

In one embodiment, when the first node is not configured with a conditional reconfiguration candidate cell, the first operation is returning to the source cell.

In one embodiment, when the first node is configured with a conditional reconfiguration candidate cell, the first operation is returning to the source cell.

Typically, when the first node is not configured with a conditional reconfiguration candidate cell, the first operation is returning to the source cell.

In one embodiment, a problem to be solved in the present application comprises: how to shorten the transmission delay.

In one embodiment, a problem to be solved in the present application comprises: how to improve the mobility performance.

In one embodiment, a problem to be solved in the present application comprises: how to avoid an RRC connection re-establishment.

In one embodiment, a problem to be solved in the present application comprises: how to ensure the optimization of mobility by simultaneously configuring DAPS and CHO.

In one embodiment, characteristics of the above method comprise: executing the second handover is performing a rapid recovery for the first handover failure through the at least one conditional reconfiguration candidate cell.

In one embodiment, characteristics of the above method comprise: a target cell for the second handover is one cell in the at least one conditional reconfiguration candidate cell.

In one embodiment, characteristics of the above method comprise: executing the second handover comprises applying an RRC configuration of a cell in the at least one conditional reconfiguration candidate cell.

In one embodiment, characteristics of the above method comprise: RRC reconfiguration information for each cell of the at least one conditional reconfiguration candidate cell is stored in a variable of the first node.

In one embodiment, the above variable comprises VarConditionalReconfig.

In one embodiment, the above variable comprises VarConditionalReconfiguration.

In one embodiment, characteristics of the above method comprise: RRC reconfiguration information of the source cell is stored in a variable of the first node.

In one embodiment, characteristics of the above method comprise: the first handover is CHO handover.

In one embodiment, characteristics of the above method comprise: the first handover is handover based on network control.

In one embodiment, characteristics of the above method comprise: the second handover is CHO handover.

In one embodiment, characteristics of the above method comprise: the handover is achieved through an RRC reconfiguration process.

In one embodiment, characteristics of the above method comprise: the handover is achieved through an RRC re-establishment procedure.

In one embodiment, characteristics of the above method comprise: if a source cell is a PCell, the handover refers to change a PCell.

In one embodiment, characteristics of the above method comprise: if a source cell is a PSCell, the handover refers to change a PSCell.

In one embodiment, characteristics of the above method comprise: the first candidate operation set also comprises executing an RRC connection re-establishment.

In one embodiment, characteristics of the above method comprise: the first candidate operation set also comprises returning to RRC_IDLE state.

In one embodiment, characteristics of the above method comprise: the returning to a source cell comprises resuming a source cell.

In one embodiment, characteristics of the above method comprise: the returning to a source cell comprises resuming an RRC configuration of a source cell.

In one embodiment, characteristics of the above method comprise: the returning to a source cell comprises resuming a DRB ((user) Data Radio Bearer) transmission.

In one embodiment, characteristics of the above method comprise: the returning to a source cell comprises resuming an SRB (Signaling Radio Bearer) transmission.

In one embodiment, advantages of the above method comprise: avoiding an RRC connection reestablishment.

In one embodiment, advantages of the above method comprise: selecting a better cell.

In one embodiment, advantages of the above method comprise: improving the mobility performance.

In one embodiment, advantages of the above method comprise: improving the robustness.

In one embodiment, advantages of the above method comprise: trade-off between latency and robustness.

According to one aspect of the present application, it is characterized in that the first node is configured with at least one conditional reconfiguration candidate cell; the first operation is related to whether there exists at least one cell in which an execution condition is satisfied in the at least one conditional reconfiguration candidate cell during the first handover; when there does not exist a cell in which an execution condition is satisfied in the at least one conditional reconfiguration candidate cell during the first handover, the first operation is returning to the source cell.

In one embodiment, characteristics of the above method comprise: as a response to the behavior of determining first handover failure, if the first node is configured with at least one conditional reconfiguration candidate cell and there exists no cell in which an execution condition is satisfied in the at least one conditional reconfiguration candidate cell during the first handover, returning to the source cell.

In one embodiment, characteristics of the above method comprise: as a response to the behavior of determining first handover failure, if the first node is configured with at least one conditional reconfiguration candidate cell and there exists at least one cell in which an execution condition is satisfied in the at least one conditional reconfiguration candidate cell during the first handover, executing the second handover.

According to an aspect of the present application, it is characterized in that the first node is configured with at least one conditional reconfiguration candidate cell, there exists at least one cell in which an execution condition is satisfied in the at least one conditional reconfiguration candidate cell during the first handover, and the first operation is related to whether the at least one cell in which an execution condition is satisfied comprises at least one target cell not used for the first node performing handover within a first time window; when the at least one cell in which an execution condition is satisfied does not comprise a target cell not used for the first node performing handover within a first time window, the first operation is returning to the source cell; when the at least one cell in which an execution condition is satisfied comprises a target cell not used for the first node performing handover within a first time window, the first operation is executing the second handover.

In one embodiment, characteristics of the above method comprise: as a response to the behavior of determining first handover failure, if the first node is configured with at least one conditional reconfiguration candidate cell and there exists at least one cell in which an execution condition is satisfied in the at least one conditional reconfiguration candidate cell during the first handover, and the at least one cell in which an execution condition is satisfied comprises a target cell not used for the first node performing handover within a first time window, executing the second handover.

In one embodiment, characteristics of the above method comprise: as a response to the behavior of determining first handover failure, if the first node is configured with at least one conditional reconfiguration candidate cell and there exists at least one cell in which an execution condition is satisfied in the at least one conditional reconfiguration candidate cell during the first handover, and the at least one cell in which an execution condition is satisfied does not comprise a target cell not used for the first node performing handover within a first time window, returning to the source cell.

According to one aspect of the present application, it is characterized in that the first node is configured with at least one conditional reconfiguration candidate cell; the first operation is related to whether there exists at least one cell in which a cell selection condition is satisfied in the at least one condition reconfiguration candidate cell while a first timer is running; when there does not exist a cell in which a cell selection condition is satisfied in the at least one conditional reconfiguration candidate cell while the first timer is running, the first operation is returning to the source cell; an expiration of the first timer is used to determine that there does not exist a cell in which a cell selection condition is satisfied.

In one embodiment, characteristics of the above method comprise: as a response to the behavior of determining first handover failure, if the first node is configured with at least one conditional reconfiguration candidate cell, and there does not exist a cell in which a cell selection condition is satisfied while the first timer is running, returning to the source cell.

In one embodiment, characteristics of the above method comprise: as a response to the behavior of determining first handover failure, if the first node is configured with at least one conditional reconfiguration candidate cell, and there exists a cell in which a cell selection condition is satisfied while the first timer is running, executing the second handover.

According to one aspect of the present application, it is characterized in that a receiver of the first signaling is configured with at least one conditional reconfiguration candidate cell, there exists at least one cell in which a cell selection condition is satisfied in the at least one conditional reconfiguration candidate cell while a first timer is running, and the first operation is related to whether the at least one cell in which a cell selection condition is satisfied comprises at least one target cell not used for a receiver of the first signaling for performing handover within a first time window; when the at least one cell in which a cell selection condition is satisfied does not comprise a target cell not used for a receiver of the first signaling for performing handover within a first time window, the first operation is returning to the source cell; when the at least one cell in which a cell selection condition is satisfied comprises a target cell not used for a receiver of the first signaling for performing handover within a first time window, the first operation is executing the second handover.

According to one aspect of the present application, it is characterized in that a receiver of the first signaling is configured with at least one conditional reconfiguration candidate cell, and the first operation is related to whether a first counter reaches a first integer; when the first counter does not reach the first integer, the first operation is returning to the source cell; if the first operation is returning to the source cell, the first counter is incremented by 1.

According to one aspect of the present application, it is characterized in that a first bearer is configured, and the first bearer is a DAPS bearer for the first cell.

According to one aspect of the present application, it is characterized in that no radio link failure occurs in the source cell during the first handover.

According to one aspect of the present application, comprising:
accompanying the configuration of the first cell is applied, starting a second timer;
herein, an expiration of the second timer is used to determine the first handover failure.

According to one aspect of the present application, comprising:
determining second handover failure; as a response to the behavior of determining second handover failure, returning to the source cell.

According to one aspect of the present application, comprising:
receiving a second signaling, the second signaling indicating a configuration of each cell in the at least one conditional reconfiguration candidate cell; and
transmitting a third signaling, the third signaling being triggered by the second signaling.

The present application provides a method in a second node for wireless communications, comprising:
transmitting a first signaling, the first signaling indicating a configuration of a first cell;
herein, a first handover from a source cell to the first cell is executed; first handover failure is determined; as a response to the first handover failure being determined, a first operation is executed; the behavior of executing a first handover from a source cell to the first cell comprises applying the configuration of the first cell; the first operation is a candidate operation in a first candidate operation set, and the first candidate operation set comprises at least two candidate operations of returning to the source cell and executing a second handover; the first operation is related to at least whether the first node is configured with at least one conditional reconfiguration candidate cell; when the first node is not configured with a conditional reconfiguration candidate cell, the first operation is returning to the source cell.

According to one aspect of the present application, it is characterized in that a receiver of the first signaling is configured with at least one conditional reconfiguration candidate cell; the first operation is related to whether there exists at least one cell in which an execution condition is satisfied in the at least one conditional reconfiguration candidate cell during the first handover; when there does not exist a cell in which an execution condition is satisfied in the at least one conditional reconfiguration candidate cell during the first handover, the first operation is returning to the source cell.

According to an aspect of the present application, it is characterized in that a receiver of the first signaling is configured with at least one conditional reconfiguration candidate cell, there exists at least one cell in which an execution condition is satisfied in the at least one conditional reconfiguration candidate cell during the first handover, and the first operation is related to whether the at least one cell in which an execution condition is satisfied comprises at least one target cell not used for a receiver of the first signaling performing handover within a first time window; when the at least one cell in which an execution condition is satisfied does not comprise a target cell not used for a receiver of the first signaling for performing handover within a first time window, the first operation is returning to the source cell; when the at least one cell in which an execution condition is satisfied comprises a target cell not used for a receiver of the first signaling for performing handover within a first time window, the first operation is executing the second handover.

According to one aspect of the present application, it is characterized in that a receiver of the first signaling is configured with at least one conditional reconfiguration candidate cell; the first operation is related to whether there exists at least one cell in which a cell selection condition is satisfied in the at least one condition reconfiguration candidate cell while a first timer is running; when there does not exist a cell in which a cell selection condition is satisfied in the at least one conditional reconfiguration candidate cell while the first timer is running, the first operation is returning to the source cell; an expiration of the first timer is used to determine that there does not exist a cell in which a cell selection condition is satisfied.

According to one aspect of the present application, it is characterized in that a receiver of the first signaling is configured with at least one conditional reconfiguration candidate cell, there exists at least one cell in which a cell selection condition is satisfied in the at least one conditional reconfiguration candidate cell while a first timer is running, and the first operation is related to whether the at least one cell in which a cell selection condition is satisfied comprises at least one target cell not used for a receiver of the first signaling for performing handover within a first time window; when the at least one cell in which a cell selection condition is satisfied does not comprise a target cell not used for a receiver of the first signaling for performing handover within a first time window, the first operation is returning to the source cell; when the at least one cell in which a cell selection condition is satisfied comprises a target cell not used for a receiver of the first signaling for performing handover within a first time window, the first operation is executing the second handover.

According to one aspect of the present application, it is characterized in that a receiver of the first signaling is configured with at least one conditional reconfiguration candidate cell, and the first operation is related to whether a first counter reaches a first integer; when the first counter does not reach the first integer, the first operation is returning to the source cell; if the first operation is returning to the source cell, the first counter is incremented by 1.

According to one aspect of the present application, it is characterized in that a first bearer is configured, and the first bearer is a DAPS bearer for the first cell.

According to one aspect of the present application, it is characterized in that no radio link failure occurs in the source cell during the first handover.

According to one aspect of the present application, it is characterized in that accompanying the configuration of the first cell is applied, a second timer is started; an expiration of the second timer is used to determine the first handover failure.

According to one aspect of the present application, it is characterized in that as a response to the behavior of determining second handover failure, returning to the source cell is executed.

According to one aspect of the present application, comprising:
transmitting a second signaling, the second signaling indicating a configuration of each cell in the at least one conditional reconfiguration candidate cell; and
receiving a third signaling, the third signaling being triggered by the second signaling.

The present application provides a first node for wireless communications, comprising:
a first receiver, receiving a first signaling, the first signaling indicating a configuration of a first cell; executing a first handover from a source cell to the first cell; determining first handover failure; and
a first transceiver, as a response to the behavior of determining first handover failure, executing a first operation;
herein, the behavior of executing a first handover from a source cell to the first cell comprises applying the configuration of the first cell; the first operation is a candidate operation in a first candidate operation set, and the first candidate operation set comprises at least two candidate operations of returning to the source cell and executing a second handover; the first operation is related to at least whether the first node is configured with at least one conditional reconfiguration candidate cell; when the first node is not configured with a conditional reconfiguration candidate cell, the first operation is returning to the source cell.

The present application provides a second node for wireless communications, comprising:
a second transmitter, transmitting a first signaling, the first signaling indicating a configuration of a first cell;
herein, a first handover from a source cell to the first cell is executed; first handover failure is determined; as a response to the first handover failure being determined, a first operation is executed; the behavior of executing a first handover from a source cell to the first cell comprises applying the configuration of the first cell; the first operation is a candidate operation in a first candidate operation set, and the first candidate operation set comprises at least two candidate operations of returning to the source cell and executing a second handover; the first operation is related to at least whether the first node is configured with at least one conditional reconfiguration candidate cell; when the first node is not configured with a conditional reconfiguration candidate cell, the first operation is returning to the source cell.

In one embodiment, the present application has the following advantages over conventional schemes:
avoiding an RRC connection re-establishment;
selecting a better cell;
improving the mobility performance;
increasing the robustness;
trade-off between latency and robustness.

### BRIEF DESCRIPTION OF THE DRAWINGS

Other features, objects and advantages of the present application will become more apparent from the detailed description of non-restrictive embodiments taken in conjunction with the following drawings:

FIG. 1 is a flowchart of transmission of a first signaling according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of radio signal transmission according to one embodiment of the present application;

FIG. 6 illustrates a schematic diagram of a first operation being related to whether there exists at least one cell in which an execution condition is satisfied in at least one conditional reconfiguration candidate cell during a first handover period according to one embodiment of the present application;

FIG. 7 illustrates a schematic diagram of a first operation being related to at least whether one cell in which an execution condition is satisfied comprises at least one target cell not used for the first node performing handover within a first time window according to one embodiment of the present application;

FIG. 8 illustrates a schematic diagram of a first operation being related to whether there exists at least one cell in which a cell selection condition is satisfied in at least one condition reconfiguration candidate cell while a first timer is running according to one embodiment of the present application;

FIG. 9 illustrates a schematic diagram of a first operation being related to at least whether one cell in which a cell selection condition is satisfied comprises at least one target cell not used for a receiver of a first signaling performing handover within a first time window according to one embodiment of the present application;

FIG. 10 illustrates a schematic diagram of a first operation being related to whether a first counter reaches a first integer according to one embodiment of the present application;

FIG. 11 illustrates a structure block diagram of a processor in a first node according to one embodiment of the present application;

FIG. 12 illustrates a structure block diagram of a processor in a second node according to one embodiment of the present application;

FIG. 13 illustrates a structure block diagram of second handover failure being used to determine returning to a source cell according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1C

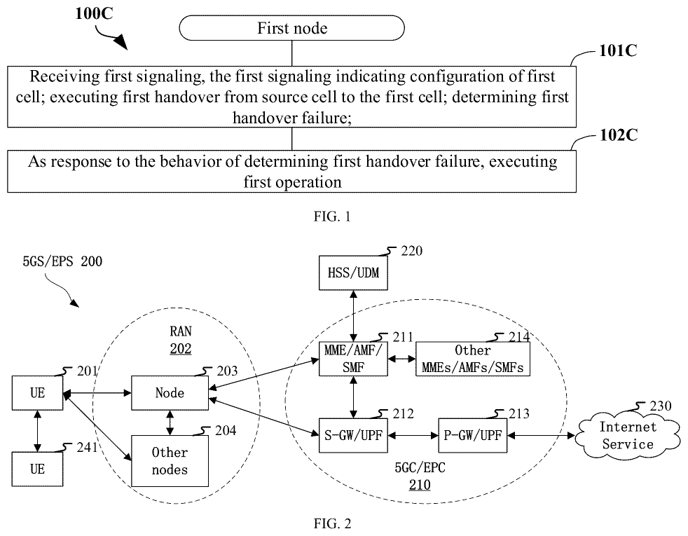

Embodiment 1C illustrates a flowchart of transmission of a first signaling according to one embodiment of the present application, as shown in FIG. 1. In FIG. 1, each box represents a step. It should be noted particularly that the order in which the boxes are arranged does not imply a chronological sequence of each step respectively marked.

In Embodiment 1C, a first node in the present application receives a first signaling in step 101C, and the first signaling indicates a configuration of a first cell; executes a first handover from a source cell to the first cell; determines first handover failure; in step 102C, as a response to the behavior of determining first handover failure, executes a first operation; herein, the behavior of executing a first handover from a source cell to the first cell comprises applying the configuration of the first cell; the first operation is a candidate operation in a first candidate operation set, and the first candidate operation set comprises at least two candidate operations of returning to the source cell and executing a second handover; the first operation is related to at least whether the first node is configured with at least one conditional reconfiguration candidate cell; when the first node is not configured with a conditional reconfiguration candidate cell, the first operation is returning to the source cell.

In one embodiment, the handover comprises a PCell handover.

In one embodiment, the handover comprises a synchronous reconfiguration.

In one embodiment, the handover comprises a PSCell change.

In one embodiment, the source cell is a source cell.

In one embodiment, the source cell is a PCell.

In one embodiment, the source cell is a PSCell.

In one embodiment, a cell group to which the source cell belongs is a source SCG (Secondary Cell Group).

In one embodiment, a cell group to which the source cell belongs is a source MCG (Master Cell Group).

In one embodiment, the first cell is a target cell.

In one embodiment, the first cell is a target PCell.

In one embodiment, the first cell is a target PSCell.

In one embodiment, a cell group to which the first cell belongs is a target SCG.

In one embodiment, a cell group to which the first cell belongs is a target MCG.

In one embodiment, the first cell is a conditional reconfiguration candidate cell.

In one embodiment, the first cell is a CPC candidate cell.

In one embodiment, the first cell is a CHO candidate cell.

In one embodiment, the first cell is a conditional reconfiguration candidate cell in the at least one conditional reconfiguration candidate cell.

In one embodiment, the first cell is the at least one cell in which an execution condition is satisfied in the at least one conditional reconfiguration candidate cell.

In one embodiment, the first cell is a triggered cell.

In one embodiment, the first cell is a selected cell.

In one embodiment, the first signaling is a downlink (DL) message.

In one embodiment, the first signaling is a sidelink message.

In one embodiment, the first signaling is transmitted through SRB1.

In one embodiment, the first signaling is transmitted through SRB3.

In one embodiment, the first signaling is transmitted on a DCCH (Dedicated Control Channel).

In one embodiment, the first signaling is an RRC-layer message.

In one embodiment, the first signaling is used for switching a configuration.

In one embodiment, the first signaling is used for configuring for a conditional reconfiguration.

In one embodiment, the first signaling is used for configuring for a CHO.

In one embodiment, the first signaling is used for configuring for a CPC.

In one embodiment, the first signaling is used for configuring for a network-based handover.

In one embodiment, the first signaling is used for configuring for a conditional reconfiguration based handover.

In one embodiment, the first signaling comprises at least one RRC message.

In one embodiment, the first signaling comprises an RRCReconfiguration message.

In one embodiment, the first signaling comprises a RRCConnectionReconfiguration message.

In one embodiment, the first signaling comprises an RRC IE (Information element), and a name of the RRC IE comprises CellGroupConfig.

In one embodiment, the first signaling comprises an RRC IE, and a name of the RRC IE comprises ServingCellConfigCommon.

In one embodiment, the first signaling comprises an RRC IE, and a name of the RRC IE comprises RACH-ConfigDedicated.

In one embodiment, the first signaling comprises an RRC IE, and a name of the RRC IE comprises RACH-ConfigDedicated.

In one embodiment, the first signaling comprises an RRC field, and a name of the RRC field comprises ReconfigurementWithSync.

In one embodiment, the first signaling comprises an RRC IE, and a name of the RRC IE comprises mobilityControlInfo.

In one embodiment, the first signaling comprises an RRC field, and a name of the RRC field comprises MobilityControlInfoSCG.

In one embodiment, the first signaling comprises an RRC field, and a name of the RRC field comprises SpCellConfig.

In one embodiment, the first signaling comprises an RRC field, and a name of the RRC field comprises masterCellGroup.

In one embodiment, the first signaling comprises an RRC field, and a name of the RRC field comprises secondaryCellGroup.

In one embodiment, the first signaling comprises an RRC IE, and a name of the RRC IE comprises ConditionalReconfiguration.

In one embodiment, the first signaling comprises an RRC IE, and a name of the RRC IE comprises CondReconfigToAddModList.

In one embodiment, the first signaling comprises an RRC IE, and a name of the RRC IE comprises CondReconfigurationToAddModList.

In one embodiment, the first signaling comprises an RRC IE, and a name of the RRC IE comprises CondReconfigId.

In one embodiment, the first signaling comprises an RRC IE, and a name of the RRC IE comprises ConditionalReconfigurationId.

In one embodiment, the first signaling comprises an RRC field, and a name of the RRC field comprises triggerCondition.

In one embodiment, the first signaling comprises an RRC field, and a name of the RRC field comprises condExecutionCond.

In one embodiment, the first signaling comprises an RRC field, and a name of the RRC field comprises condRRCReconfig.

In one embodiment, the first signaling comprises an RRC field, and a name of the RRC field comprises condReconfigurationToApply.

In one embodiment, the first signaling does not comprises an RRC IE whose name comprises ConditionalReconfiguration.

In one embodiment, the first signaling does not comprise an RRC IE whose name comprises CondReconfigToAddModList or CondReconfigurationToAddModList.

In one embodiment, the first signaling does not comprise an RRC IE whose name comprises CondReconfigId or ConditionalReconfigurationId.

In one embodiment, the first signaling does not comprise an RRC field whose name comprises condExecutionCond or triggerCondition.

In one embodiment, the first signaling does not comprise an RRC IE whose name comprises condRRCReconfig or condReconfigurementToApply.

In one embodiment, the phrase that the first signaling indicates a configuration of a first cell comprises: the first signaling comprises configuration information of the first cell.

In one embodiment, the phrase that the first signaling indicates a configuration of a first cell comprises: the first signaling is used for configuring for the first cell.

In one embodiment, the phrase that the first signaling indicates a configuration of a first cell comprises: the first signaling comprises parameters for the synchronous reconfiguration to the first cell.

In one embodiment, the phrase that the first signaling indicates a configuration of a first cell comprises: the first signaling comprises cell specific parameters of the first cell.

In one embodiment, the first signaling comprises a cell identifier for the first cell.

In one embodiment, the first signaling comprises an identifier of the first node in the first cell.

In one embodiment, the behavior of applying the configuration of the first cell comprises at least one of the following behaviors:
starting synchronizing to downlink of the first cell;
applying a BCCH (Broadcast Channel) configuration of the first cell;
obtaining an MIB (Master Information Block) of the first cell, and refer to 3GPP TS 38.213 for scheduling of the MIB;
using a value of newUE-Identity in the first signaling as a C-RNTI (Cell Radio Network Temporary identifier) of the first node in a cell group to which the first cell belongs;
configuring a lower layer of the first cell according to spCellConfigCommon in the first signaling;
configuring a lower layer of the first cell according to other fields in the first signaling;
applying the configuration of the first cell;
executing a random access procedure on the first cell.

In one embodiment, the behavior of executing a first handover from a source cell to the first cell comprises: transmitting Msg1 (Message 1) on the first cell, and the Msg1 comprises a random access preamble.

In one embodiment, the behavior of executing a first handover from a source cell to the first cell comprises: receiving Msg2 (Message 2) on the first cell, and the Msg2 comprises at least RAR (Random Access Response).

In one embodiment, the behavior of executing a first handover from a source cell to the first cell comprises: transmitting Msg3 (Message 3) on the first cell, and the Msg3 comprises at least a C-RNTI MAC (Medium Access Control) CE (Control Element).

In one embodiment, the behavior of executing a first handover from a source cell to the first cell comprises: receiving Msg4 (Message 4) on the first cell, and the Msg4 comprises at least a UE Content Resolution Identity MAC CE.

In one embodiment, the behavior of executing a first handover from a source cell to the first cell comprises: transmitting MsgA (Message A) on the first cell, and the MsgA comprises at least a random access preamble and a C-RNTI MAC CE.

In one embodiment, the behavior of executing a first handover from a source cell to the first cell comprises: receiving MsgB on the first cell, and the MsgB comprises a PDCCH (Physical Downlink Control Channel).

In one subembodiment of the above embodiment, the MsgB is fallbackRAR.

In one subembodiment of the above embodiment, the MsgB is successRAR.

In one embodiment, the behavior of executing a first handover from a source cell to the first cell comprises: transmitting a RRC connection re-establishment completion message on the first cell.

In one embodiment, the RRC connection re-establishment complete message comprises an RRCReconfigurationComplete message.

In one embodiment, the RRC connection re-establishment complete message comprises an RRCConnectionReconfigurationComplete message.

In one embodiment, the behavior of determining first handover failure comprises: determining Reconfiguration with sync Failure.

In one embodiment, the behavior of determining first handover failure comprises: detecting the first handover failure.

In one embodiment, the behavior of determining first handover failure comprises: assuming that the first handover failure occurs.

In one embodiment, during the first handover process, a random access procedure failure executed on the first cell is used to determine the first handover failure.

In one embodiment, during the first handover process, a random access issue indication received from the MAC layer is used to determine the first handover failure.

In one embodiment, accompanying the configuration of the first cell is applied, a second timer is started; an expiration of the second timer is used to determine the first handover failure.

In one embodiment, the second timer is T304.

In one embodiment, the second timer is T307.

In one embodiment, an expiration of the second timer refers to the second timer reaching its expiration value.

In one embodiment, an expiration of the second timer refers to a running time of the second timer reaching its expiration value.

In one embodiment, an expiration of the second timer refers to a timing the second timer reaching its expiration value.

In one embodiment, an expiration of the second timer refers to that a time interval from a time when the second timer being started to a time when the second timer expires is not less than an expiration value of the second timer.

In one embodiment, an expiration value of the second timer is configured through an RRC message.

In one embodiment, an expiration value of the second timer is configurable.

In one embodiment, the behavior of starting a second timer refers to: starting the second timer.

In one embodiment, the behavior of starting a second timer refers to: the second timer starts timing.

In one embodiment, the behavior of starting a second timer refers to: the second timer starts running.

In one embodiment, an initial value of the second timer is equal to 0.

In one embodiment, a time interval from a start time to an expiration time of the second timer is not restarted.

In one embodiment, the second timer belongs to a cell group to which the source cell belongs.

In one embodiment, the source cell is a PCell, and the second timer belongs to an MCG.

In one embodiment, the phrase of as a response to the behavior of determining first handover failure comprises: when the first handover failure is determined.

In one embodiment, the phrase of as a response to the behavior of determining first handover failure comprises: if the first handover failure is detected.

In one embodiment, the phrase of as a response to the behavior of determining first handover failure comprises: if the second timer expires.

In one embodiment, the behavior of executing a first handover from a source cell to the first cell refers to apply the configuration of the first cell.

In one embodiment, the behavior of executing a first handover from a source cell to the first cell comprises at least applying the configuration of the first cell.

In one embodiment, the first operation set also comprises returning RRC_IDLE state.

In one embodiment, the first operation set also comprises executing an RRC connection re-establishment procedure.

In one embodiment, the behavior of returning to the source cell comprises at least one of the following behaviors:
resuming suspended SRBs in the source cell.
for each non-DAPS bearer, reverting back to the UE configuration used for the DRB in the source cell, including PDCP, RLC state variables, security configuration, and data stored in transmission and reception buffers in PDCP and RLC entities.
reverting back to the UE measurement configuration used in the source cell.

In one embodiment, if the first node is configured with at least one conditional reconfiguration candidate cell, and the first operation is to execute the second handover, a target cell of the second handover is the second cell, and the second cell is a conditional reconfiguration candidate cell in the at least one conditional reconfiguration candidate cell.

In one subembodiment of the embodiment, the second cell is a cell in which an execution condition is satisfied in the at least one conditional reconfiguration candidate cell.

In one subembodiment of the embodiment, the second cell is a cell in which a cell selection condition is satisfied in the at least one conditional reconfiguration candidate cell.

In one subembodiment of the embodiment, the second cell is a triggering cell in the at least one conditional reconfiguration candidate cell.

In one subembodiment of the embodiment, the second cell is a selected cell in the at least one conditional reconfiguration candidate cell.

In one subembodiment of the embodiment, the second cell is a target cell used for the second handover in the at least one conditional reconfiguration candidate cell.

In one subembodiment of the embodiment, the second cell is a conditional reconfiguration candidate cell indicated by CondReconfigId.

In one embodiment, the second cell is the same as the first cell.

In one embodiment, the second cell is different from the first cell.

In one embodiment, the behavior of executing a second handover comprises at least one of the following behaviors:
starting synchronizing to downlink of the second cell;
applying a BCCH (Broadcast Channel) configuration of the second cell;
obtaining an MIB (Master Information Block) of the second cell, and refer to 3GPP TS 38.213 for scheduling of the MIB;
executing the identifier (newUE-Identity) of the first node U01 in the second cell comprised in a synchronization reconfiguration with the second cell as a target cell as a C-RNTI of the first node in a cell group to which the second cell belongs;
configuring a lower layer of the second cell based on spCellConfigCommon targeting the second cell;
configuring a lower layer of the second cell according to other configurations specific to the second cell;
executing reconfiguration with sync;
executing a random access procedure on the second cell;
transmitting an RRC connection re-establishment complete message on the second cell.

In one embodiment, the phrase that the first operation is related to at least whether the first node is configured with at least one conditional reconfiguration candidate cell comprises: whether the first node is configured with at least one conditional re-configuration candidate cell is used to determine the first operation.

In one embodiment, the phrase that the first operation is related to at least whether the first node is configured with at least one conditional reconfiguration candidate cell comprises: whether the first node is configured with at least one conditional re-configuration candidate cell is used to determine whether the second handover is executed.

In one embodiment, the phrase that the first operation is related to at least whether the first node is configured with at least one conditional reconfiguration candidate cell comprises: whether the first node is configured with at least one conditional re-configuration candidate cell is used to determine whether to return to the source cell.

In one embodiment, the phrase that the first operation is related to at least whether the first node is configured with at least one conditional reconfiguration candidate cell comprises: whether the first node is configured with at least one conditional re-configuration candidate cell is used to determine to return to the source cell or execute the second handover.

In one embodiment, the phrase that the first operation is related to at least whether the first node is configured with at least one conditional reconfiguration candidate cell comprises: the first operation is only related to at least whether the first node is configured with at least one conditional reconfiguration candidate cell.

In one embodiment, the phrase that the first operation is related to at least whether the first node is configured with at least one conditional reconfiguration candidate cell comprises: the first operation is related to whether the first node is configured with at least one conditional reconfiguration candidate cell, and the first operation is related to whether there exists at least one cell in which an execution condition is satisfied in the at least one conditional reconfiguration candidate cell during the first handover.

In one embodiment, the phrase that the first operation is related to at least whether the first node is configured with at least one conditional reconfiguration candidate cell comprises: the first operation is related to whether the first node is configured with at least one conditional reconfiguration candidate cell, and the first operation is related to whether there exists at least one cell selection condition satisfied in the at least one conditional reconfiguration candidate cell while a first timer is running.

In one embodiment, the phrase that the first operation is related to at least whether the first node is configured with at least one conditional reconfiguration candidate cell comprises: the first operation is related to whether the first node is configured with at least one conditional reconfiguration candidate cell, and the first operation is related to whether the at least one cell in which an execution condition is satisfied comprises at least one target cell not used for the first node performing handover within a first time window.

In one embodiment, the phrase that the first operation is related to at least whether the first node is configured with at least one conditional reconfiguration candidate cell comprises: the first operation is related to whether the first node is configured with at least one conditional reconfiguration candidate cell, and the first operation is related to whether the first bearer is configured.

In one embodiment, the phrase that the first operation is related to at least whether the first node is configured with at least one conditional reconfiguration candidate cell comprises: the first operation is related to whether the first node is configured with at least one conditional reconfiguration candidate cell, and the first operation is related to whether radio link failure occurs in the source cell during the first handover.

In one embodiment, the phrase that the first operation is related to at least whether the first node is configured with at least one conditional reconfiguration candidate cell comprises: the first operation is related to whether the first node is configured with at least one conditional reconfiguration candidate cell, and the first operation is related to whether a first counter reaches a first integer.

In one embodiment, the first bearer is configured, and the first bearer is a DAPS bearer for the first cell; no radio link failure occurs in the source cell during the first handover; the first operation is related to at least whether the first node is configured with at least one conditional reconfiguration candidate cell.

In one embodiment, the first bearer is configured, and the first bearer is a DAPS bearer for the first cell; no radio link failure occurs in the source cell during the first handover; the first operation is related to at least whether the first node is configured with at least one conditional reconfiguration candidate cell; if the first node is configured with at least one conditional reconfiguration candidate cell, and the first operation is related to whether there exists at least one cell in which an execution condition is satisfied in the at least one conditional reconfiguration candidate cell during the first handover.

In one embodiment, the first bearer is configured, and the first bearer is a DAPS bearer for the first cell; no radio link failure occurs in the source cell during the first handover; the first operation is related to at least whether the first node is configured with at least one conditional reconfiguration candidate cell; if the first node is configured with at least one conditional reconfiguration candidate cell, and the first operation is related to whether there exists at least one cell in which an execution condition is satisfied in the at least one conditional reconfiguration candidate cell during the first handover; if there exists at least one cell in which an execution condition is satisfied in the at least one conditional reconfiguration candidate cell during the first handover, and the first operation is related to whether the at least one cell in which an execution condition is satisfied comprises at least one target cell not used for the first node performing handover within a first time window.

In one embodiment, the first bearer is configured, and the first bearer is a DAPS bearer for the first cell; no radio link failure occurs in the source cell during the first handover; the first operation is related to at least whether the first node is configured with at least one conditional reconfiguration candidate cell; if the first node is configured with at least one conditional reconfiguration candidate cell, the first operation is related to whether there exists at least one cell in which a cell selection condition is satisfied in the at least one condition re-configuration candidate cell while a first timer is running.

In one embodiment, the first bearer is configured, and the first bearer is a DAPS bearer for the first cell; no radio link failure occurs in the source cell during the first handover; the first operation is related to at least whether the first node is configured with at least one conditional reconfiguration candidate cell; if the first node is configured with at least one conditional reconfiguration candidate cell, the first operation is related to whether there exists at least one cell in which a cell selection condition is satisfied in the at least one condition re-configuration candidate cell while a first timer is running; if there exists a cell in which a cell selection condition is satisfied in the at least one conditional reconfiguration candidate cell while the first timer is running, the first operation is related to when the at least one cell in which a cell selection condition is satisfied comprises at least one target cell not used for the first node performing handover within a first time window.

In one embodiment, the first bearer is configured, and the first bearer is a DAPS bearer for the first cell; no radio link failure occurs in the source cell during the first handover; the first operation is related to at least whether the first node is configured with at least one conditional reconfiguration candidate cell; if the first node is configured with at least one conditional reconfiguration candidate cell, the first operation is related to whether a first counter reaches a first integer.

In one embodiment, whether the first node is configured with at least one conditional reconfiguration candidate cell is determined based on whether there exists at least one entry in VarConditionalReconfig.

In one embodiment, whether the first node is configured with at least one conditional reconfiguration candidate cell is determined based on whether there exists at least one entry in VarConditionalReconfiguration.

In one subembodiment of the embodiment, if VarConditionalReconfig comprises at least one entry, the first node is configured with at least one conditional reconfiguration candidate cell.

In one subembodiment of the embodiment, if VarConditionalReconfiguration comprises at least one entry, the first node is configured with at least one conditional reconfiguration candidate cell.

In one subembodiment of the embodiment, if VarConditionalReconfig does not comprise any entry, the first node is not configured with at least one conditional reconfiguration candidate cell.

In one subembodiment of the embodiment, if no entry is comprised in VarConditionalReconfiguration, the first node is not configured with at least one conditional reconfiguration candidate cell.

In one embodiment, when the first node is not configured with a conditional reconfiguration candidate cell, the first operation is returning to the source cell.

In one embodiment, when the first node is configured with a conditional reconfiguration candidate cell, the first operation is executing the second handover.

In one embodiment, the first node evaluates for an execution condition of the at least one condition re-configuration candidate cell during the first handover.

In one embodiment, the first node does not evaluate for an execution condition of the at least one condition re-configuration candidate cell during the first handover.

In one embodiment, the first node decides whether to evaluate for an execution condition of the at least one condition re-configuration candidate cell during the first handover.

In one embodiment, when the first node is not configured with a conditional reconfiguration candidate cell, the first operation is returning to the source cell; herein, the first bearer is configured, and radio link failure does not occur in the source cell during the first handover.

In one embodiment, when the first node is not configured with a conditional reconfiguration candidate cell, the first operation is returning to the source cell; herein, the first bearer is not configured, and radio link failure does not occur in the source cell during the first handover.

In one embodiment, when the first node is configured with a conditional reconfiguration candidate cell, the first operation is returning to the source cell; herein, the first bearer is configured, and radio link failure does not occur in the source cell during the first handover.

In one embodiment, when the first node is configured with a conditional reconfiguration candidate cell, the first operation is returning to the source cell; herein, the first bearer is not configured, and radio link failure does not occur in the source cell during the first handover.

In one embodiment, when the first node is configured with a conditional reconfiguration candidate cell, the first operation is executing the second handover; herein, the first bearer is not configured.

In one embodiment, when the first node is configured with a conditional reconfiguration candidate cell, the first operation is executing the second handover; herein, the first bearer is not configured, and radio link failure occurs in the source cell during the first handover.

In one embodiment, when the first node is configured with a conditional reconfiguration candidate cell, the first operation is executing the second handover; herein, the first bearer is configured, and radio link failure occurs in the source cell during the first handover.

In one embodiment, if the first operation is to execute the second handover, as a response to the second handover being initiated, all entries in VarConditionalReconfig are removed.

In one embodiment, if the first operation is to execute the second handover, as a response to the second handover being initiated, a configuration of the at least one conditional reconfiguration candidate cell is released.

### Embodiment 2

Embodiment 2 illustrates a schematic diagram of a network architecture according to one embodiment of the present application, as shown in FIG. 2. FIG. 2 is a diagram illustrating a network architecture 200 of 5G NR/Long-Term Evolution (LTE)/Long-Term Evolution Advanced (LTE-A) systems. The 5G NR/LTE/LTE-A network architecture 200 may be called a 5G System (5GS)/Evolved Packet System (EPS) 200 or other appropriate terms. The 5GS/EPS 200 comprises at least one of a UE 201, an RAN 202, a 5G Core Network/Evolved Packet Core (5GC/EPC) 210, a Home Subscriber Server (HSS)/Unified Data Management (UDM) 220 or an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will readily understand that various concepts presented throughout the present application can be extended to networks providing circuit switching services or other cellular networks. The RAN comprises the node 203 and other nodes 204. The node 203 provides UE 201-oriented user plane and control plane protocol terminations. The node 203 may be connected to other nodes 204 via an Xn interface (e.g., backhaul)/X2 interface. The node 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The node 203 provides an access point of the 5GC/EPC 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPS), multimedia devices, video devices, digital audio players (for example, MP3 players), cameras, game consoles, unmanned aerial vehicles (UAV), aircrafts, narrow-band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The node 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the UE 201 corresponds to the first node in the present application.

In one embodiment, the UE 201 is a UE.

In one embodiment, the UE 201 is a BaseStation (BS).

In one embodiment, the node 203 corresponds to the second node in the present application.

In one embodiment, the node 203 is a base station.

In one embodiment, the node 203 is a Base Transceiver Station (BTS).

In one embodiment, the node 203 is a NodeB (NB).

In one embodiment, the node 203 is a gNB.

In one embodiment, the node 203 is an eNB.

In one embodiment, the node 203 is an ng-eNB.

In one embodiment, the node 203 is an en-gNB.

In one embodiment, the node 203 is a UE.

In one embodiment, the node 203 is a relay device.

In one embodiment, the node 203 is a gateway.

In one embodiment, the node 204 corresponds to the third node in the present application.

In one embodiment, the node 204 is a BS.

In one embodiment, the node 204 is a BTS.

In one embodiment, the node 204 is an NB.

In one embodiment, the node 204 is a gNB.

In one embodiment, the node 204 is an eNB.

In one embodiment, the node 204 is an ng-eNB.

In one embodiment, the node 204 is an en-gNB.

In one embodiment, the node 204 is a UE.

In one embodiment, the node 204 is a relay device.

In one embodiment, the node 204 is a gateway.

In one embodiment, the UE supports Terrestrial Network (NTN) transmission.

In one embodiment, the UE supports Non-Terrestrial Network (NTN) transmission.

In one embodiment, the UE supports communications within networks with large latency differences.

In one embodiment, the UE supports Dual Connection (DC) transmission.

In one embodiment, the UE comprises an aircraft.

In one embodiment, the UE comprises a vehicle terminal.

In one embodiment, the UE comprises a vessel.

In one embodiment, the UE comprises an Internet of Things (IoT) terminal.

In one embodiment, the UE comprises an Industrial Internet of Things (IIoT) terminal.

In one embodiment, the UE comprises a device supporting transmission with low-latency and high-reliability.

In one embodiment, the UE comprises test equipment.

In one embodiment, the UE comprises a signaling tester.

In one embodiment, the base station supports transmission over a non-terrestrial network.

In one embodiment, the base station supports transmission over networks with large latency differences.

In one embodiment, the base station supports transmission over a terrestrial network.

In one embodiment, the base station comprises a Marco Cellular base station.

In one embodiment, the base station comprises a Micro Cell base station.

In one embodiment, the base station comprises a Pico Cell base station.

In one embodiment, the base station comprises a Femtocell.

In one embodiment, the base station comprises a base station supporting large latency differences.

In one embodiment, the base station comprises flight platform equipment.

In one embodiment, the base station comprises satellite equipment.

In one embodiment, the base station comprises a Transmitter Receiver Point (TRP).

In one embodiment, the base station comprises a Centralized Unit (CU).

In one embodiment, the base station comprises a Distributed Unit (DU).

In one embodiment, the base station comprises test equipment.

In one embodiment, the base station comprises a signaling tester.

In one embodiment, the base station comprises an Integrated Access and Backhaul (IAB)-node.

In one embodiment, the base station comprises an IAB-donor.

In one embodiment, the base station comprises an IAB-donor-CU.

In one embodiment, the base station comprises an IAB-donor-DU.

In one embodiment, the base station comprises an IAB-DU.

In one embodiment, the base station comprises an IAB-MT.

In one embodiment, the relay comprises a relay.

In one embodiment, the relay device comprises an L3 relay.

In one embodiment, the relay device comprises an L2 relay.

In one embodiment, the relay device comprises a router.

In one embodiment, the relay device comprises a switch.

In one embodiment, the relay device comprises a UE.

In one embodiment, the relay device comprises a base station.

In one embodiment, the first node is a base station, the second node is a base station, and the third node is a base station.

In one embodiment, the first node is a UE, and the second node is a UE, and the third node is a UE.

In one embodiment, the first node is a UE, the second node is a relay device, and the third node is a relay device.

In one embodiment, the first node is a base station, and the second node is a UE, and the third node is a UE.

In one subembodiment of the embodiment, the second node is a source base station of the first node, and the third node is a target base station of the first node.

In one subembodiment of the embodiment, the second node is a maintenance base station of the first serving cell, and the third node is a maintenance base station of the first candidate cell.

In one embodiment, the second node is an NR device, and the third base station is an NR device.

In one embodiment, the second node is an NR device, and the third base station is an LTE device.

In one embodiment, the second node is an LTE device, and the third base station is an NR device.

In one embodiment, the second node is an LTE device, and the third base station is an LTE device.

In one embodiment, the first node is a device that supports NR.

In one embodiment, the first node is a device that supports LTE.

In one embodiment, in at least one slot that the first configuration is applied, the first node is connected to the second node and the third node through a DAPS at the same time.

In one embodiment, during DAPS reconfiguration period, the first node is connected to both the second node and the third node through a DAPS at the same time.

In one embodiment, if the first bearer is a DAPS bearer configured for the first cell, at least one slot of a synchronous reconfiguration with the first cell as the target cell is executed, and the first node is connected to both the second node and the third node through a DAPS at the same time.

### Embodiment 3

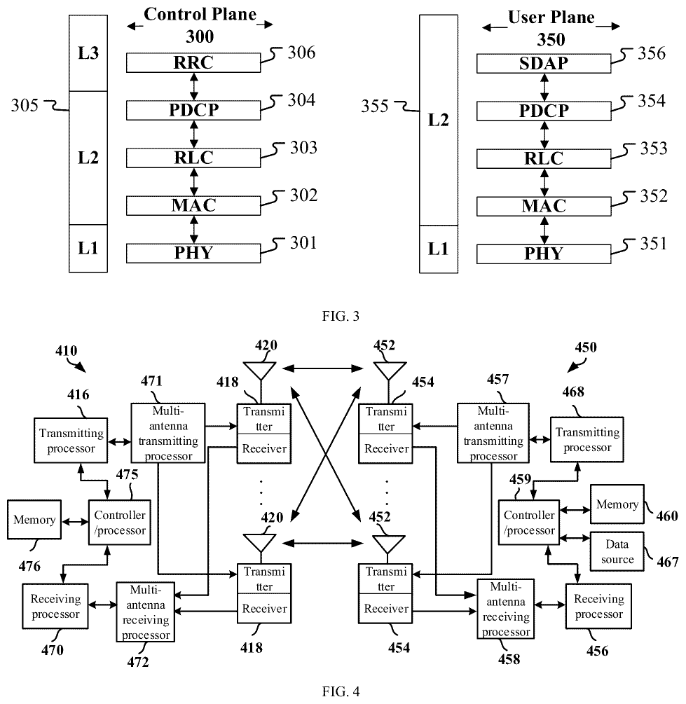

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for the control plane 300 is represented by three layers, which are a layer 1, a layer 2 and a layer 3, respectively. The layer 1 (L1) is the lowest layer and performs signal processing functions of various PHY layers. The L1 is called PHY 301 in the present application. L2 305, above the PHY 301, comprises a Medium Access Control (MAC) sublayer 302, a Radio Link Control (RLC) sublayer 303 and a Packet Data Convergence Protocol (PDCP) sublayer 304. The PDCP sublayer 304 provides multiplexing among variable radio bearers and logical channels. The PDCP sublayer 304 provides security by encrypting a data packet and provides support for performing handover. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating various radio resources (i.e., resources block) in a cell. The MAC sublayer 302 is also in charge of HARQ operation. The RRC sublayer 306 in L3 layer of the control plane 300 is responsible for acquiring radio resources (i.e., radio bearer) and configuring the lower layer with an RRC signaling. The radio protocol architecture of the user plane 350 comprises layer 1 (L1) and layer 2 (L2). In the user plane 350, the radio protocol architecture is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic.

In one embodiment, the radio protocol architecture in FIG. 3 is applicable to the first node in the present application.

In one embodiment, the radio protocol architecture in FIG. 3 is applicable to the second node in the present application.

In one embodiment, the radio protocol architecture in FIG. 3 is applicable to the third node in the present application.

In one embodiment, the radio protocol architecture in FIG. 3 is applicable to the fourth node in the present application.

In one embodiment, the first signaling in the present application is generated by the RRC 306.

In one embodiment, the first signaling in the present application is generated by the MAC 302 or the MAC 352.

In one embodiment, the first signaling in the present application is generated by the PHY 301 or the PHY 351.

In one embodiment, the second signaling in the present application is generated by the RRC 306.

In one embodiment, the second signaling in the present application is generated by the MAC 302 or the MAC 352.

In one embodiment, the second signaling in the present application is generated by the PHY 301 or the PHY 351.

In one embodiment, the third signaling in the present application is generated by the RRC 306.

In one embodiment, the third signaling in the present application is generated by the MAC 302 or the MAC 352.

In one embodiment, the third signaling in the present application is generated by the PHY 301 or the PHY 351.

### Embodiment 4

Embodiment 4 illustrates a schematic diagram of a first communication device and a second communication device in the present application, as shown in FIG. 4. FIG. 4 is a block diagram of a first communication device 450 in communication with a second communication device 410 in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the first communication device 410, a higher layer packet from the core network is provided to a controller/processor 475. The controller/processor 475 provides a function of the L2 layer. In the transmission from the second communication device 410 to the first communication device 450, the controller/processor 475 provides header compression, encryption, packet segmentation and reordering, and multiplexing between a logical channel and a transport channel, and radio resources allocation for the first communication device 450 based on various priorities. The controller/processor 475 is also responsible for retransmission of a lost packet and a signaling to the first communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 410 side, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the second communication device 410 to the first communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT.

In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the first communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the second communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the second communication device 410 to the second communication device 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the first communication device 450 to the second communication device 410, at the second communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the second communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first communication device 450 comprises at least one processor and at least one memory. at least one processor and at least one memory. The at least one memory comprises computer program codes; the at least one memory and the computer program codes are configured to be used in collaboration with the at least one processor, the first communication device 450 at least: receives a first signaling, the first signaling is used to determine at least a first condition and a first configuration, the first condition and the first configuration are associated with a first candidate cell; transmits a second signaling, the second signaling is used for confirming against the first signaling; as a response to the first condition being satisfied, determines whether to transmit a third signaling on a first serving cell based on at least whether a first bearer is configured, the first bearer is a DAPS bearer, the third signaling is used to indicate that the first condition is satisfied; herein, the first serving cell is a source serving cell of the first node, and the first candidate cell is a target candidate cell of the first node; the first configuration comprises at least an identifier of the first node in the first candidate cell and a cell identifier of the first candidate cell; the behavior of determining whether to transmit a third signaling on a first serving cell according to at least whether a first bearer is configured comprises: if the first bearer is configured, transmitting the third signaling on the first serving cell; if the first bearer is not configured, not transmitting the third signaling on the first serving cell; the first communication device 450 corresponds to a first node in the present application, and the second communication device 410 corresponds to a second node in the present application.

In one embodiment, the first communication device 450 comprises at least one processor and at least one memory. a memory that stores a computer readable instruction program. The computer readable instruction program generates an action when executed by at least one processor. The action includes: receiving a first signaling, the first signaling being used to determine at least a first condition and a first configuration, the first condition and the first configuration being associated with a first candidate cell; transmitting a second signaling, the second signaling being used for confirming against the first signaling; as a response to the first condition being satisfied, determining whether to transmit a third signaling on a first serving cell based on at least whether a first bearer is configured, the first bearer is a DAPS bearer, the third signaling being used to indicate that the first condition is satisfied; herein, the first serving cell is a source serving cell of the first node, and the first candidate cell is a target candidate cell of the first node; the first configuration comprises at least an identifier of the first node in the first candidate cell and a cell identifier of the first candidate cell; the behavior of determining whether to transmit a third signaling on a first serving cell according to at least whether a first bearer is configured comprises: if the first bearer is configured, transmitting the third signaling on the first serving cell; if the first bearer is not configured, not transmitting the third signaling on the first serving cell; the first communication device 450 corresponds to a first node in the present application, and the second communication device 410 corresponds to a second node in the present application.

In one embodiment, the second communication device 410 comprises at least one processor and at least one memory. The at least one memory comprises computer program codes; the at least one memory and the computer program codes are configured to be used in collaboration with the at least one processor. The second communication device 410 at least: transmits a first signaling, the first signaling is used to determine at least a first condition and a first configuration, the first condition and the first configuration is associated with a first candidate cell; receives a second signaling, the second signaling is used for confirming against the first signaling; receives a third signaling; herein, the first condition is satisfied and a first bearer is configured to determine that the third signaling is transmitted in the first serving cell, the first bearer is a DAPS bearer, and the third signaling is used to indicate that the first condition is satisfied; the first configuration comprises an identifier of at least a receiver of the first signaling in the first candidate cell and a cell identifier of the first candidate cell; the first serving cell is a source serving cell of a receiver of the first signaling, and the first candidate cell is a target candidate cell of a receiver of the first signaling; the first communication device 450 corresponds to a first node in the present application, and the second communication device 410 corresponds to a second node in the present application.

In one embodiment, the second communication device 410 comprises a memory that stores a computer readable instruction program. The computer readable instruction program generates an action when executed by at least one processor. The action includes: transmitting a first signaling, the first signaling being used to determine at least a first condition and a first configuration, the first condition and the first configuration being associated with a first candidate cell; receiving a second signaling, the second signaling being used for confirming against the first signaling; receiving a third signaling; herein, the first condition is satisfied and a first bearer is configured to determine that the third signaling is transmitted in the first serving cell, the first bearer is a DAPS bearer, and the third signaling is used to indicate that the first condition is satisfied; the first configuration comprises an identifier of at least a receiver of the first signaling in the first candidate cell and a cell identifier of the first candidate cell; the first serving cell is a source serving cell of a receiver of the first signaling, and the first candidate cell is a target candidate cell of a receiver of the first signaling; the first communication device 450 corresponds to a first node in the present application, and the second communication device 410 corresponds to a second node in the present application.

In one embodiment, the first communication device 450 comprises at least one processor and at least one memory. at least one processor and at least one memory. The at least one memory comprises computer program codes; the at least one memory and the computer program codes are configured to be used in collaboration with the at least one processor, the first communication device 450 at least: as a response to the behavior of receiving a third signaling, transmits a first message, the first message is used to indicate a PDCP SN and HFN of a target PDCP SDU, and the target PDCP SDU is the first one of forwarded PDCP SDUs of the first bearer; the first communication device 450 corresponds to a third node in the present application, and the second communication device 410 corresponds to a second node in the present application.

In one embodiment, the first communication device 450 comprises at least one processor and at least one memory. a memory that stores a computer readable instruction program. The computer readable instruction program generates an action when executed by at least one processor. The action includes: as a response to the behavior of receiving a third signaling, transmitting a first message, the first message being used to indicate a PDCP SN and HFN of a target PDCP SDU, and the target PDCP SDU being the first one of forwarded PDCP SDUs of the first bearer; the first communication device 450 corresponds to a third node in the present application, and the second communication device 410 corresponds to a second node in the present application.

In one embodiment, the first communication device 450 comprises at least one processor and at least one memory. at least one processor and at least one memory. The at least one memory comprises computer program codes; the at least one memory and the computer program codes are configured to be used in collaboration with the at least one processor, the first communication device 450 at least: receives a first signaling, the first signaling indicates a configuration of a first cell; executes a first handover from a source cell to the first cell; determines first handover failure; as a response to the behavior of determining first handover failure, executes a first operation; herein, the behavior of executing a first handover from a source cell to the first cell comprises applying the configuration of the first cell; the first operation is a candidate operation in a first candidate operation set, and the first candidate operation set comprises at least two candidate operations of returning to the source cell and executing a second handover; the first operation is related to at least whether the first node is configured with at least one conditional reconfiguration candidate cell; when the first node is not configured with a conditional reconfiguration candidate cell, the first operation is returning to the source cell.

In one embodiment, the first communication device 450 comprises at least one processor and at least one memory. a memory that stores a computer readable instruction program. The computer readable instruction program generates an action when executed by at least one processor. The action includes: receiving a first signaling, the first signaling indicating a configuration of a first cell; executing a first handover from a source cell to the first cell; determining first handover failure; as a response to the behavior of determining first handover failure, executing a first operation; herein, the behavior of executing a first handover from a source cell to the first cell comprises applying the configuration of the first cell; the first operation is a candidate operation in a first candidate operation set, and the first candidate operation set comprises at least two candidate operations of returning to the source cell and executing a second handover; the first operation is related to at least whether the first node is configured with at least one conditional reconfiguration candidate cell; when the first node is not configured with a conditional reconfiguration candidate cell, the first operation is returning to the source cell.

In one embodiment, the second communication device 410 comprises at least one processor and at least one memory. The at least one memory comprises computer program codes; the at least one memory and the computer program codes are configured to be used in collaboration with the at least one processor. The second communication device 410 at least: transmits a first signaling, the first signaling indicates a configuration of a first cell; herein, a first handover from a source cell to the first cell is executed; first handover failure is determined; as a response to the first handover failure being determined, a first operation is executed; the behavior of executing a first handover from a source cell to the first cell comprises applying the configuration of the first cell; the first operation is a candidate operation in a first candidate operation set, and the first candidate operation set comprises at least two candidate operations of returning to the source cell and executing a second handover; the first operation is related to at least whether the first node is configured with at least one conditional reconfiguration candidate cell; when the first node is not configured with a conditional reconfiguration candidate cell, the first operation is returning to the source cell.

In one embodiment, the second communication device 410 comprises a memory that stores a computer readable instruction program. The computer readable instruction program generates an action when executed by at least one processor. The action includes: transmitting a first signaling, the first signaling indicating a configuration of a first cell; herein, a first handover from a source cell to the first cell is executed; first handover failure is determined; as a response to the first handover failure being determined, a first operation is executed; the behavior of executing a first handover from a source cell to the first cell comprises applying the configuration of the first cell; the first operation is a candidate operation in a first candidate operation set, and the first candidate operation set comprises at least two candidate operations of returning to the source cell and executing a second handover; the first operation is related to at least whether the first node is configured with at least one conditional reconfiguration candidate cell; when the first node is not configured with a conditional reconfiguration candidate cell, the first operation is returning to the source cell.

In one embodiment, the antenna 452, the receiver 454, the receiving processor 456, the controller/processor 459 are used to receive a first signaling; at least one of the antenna 420, the transmitter 418, the transmitting processor 416, or the controller/processor 475 is used to transmit the first signaling.

In one embodiment, the antenna 452, the transmitter 454, the transmitting processor 468, and the controller/processor 459 are used to transmit a second signaling; at least one of the antenna 420, the receiver 418, the receiving processor 470, or the controller/processor 475 is used to receive a second signaling.

In one embodiment, the antenna 452, the transmitter 454, the transmitting processor 468 and the controller/processor 459 are used to transmit a third signaling; at least one of the antenna 420, the receiver 418, the receiving processor 470 or the controller/processor 475 is used to receive the third signaling.

In one embodiment, the antenna 452, the receiver 454, the receiving processor 456, and the controller/processor 459 is used to receive at least one of MIB, PBCH, Msg2, Msg4, or MsgB; at least one of the antenna 420, the transmitter 418, the transmitting processor 416, or the controller/processor 475 is used to transmit at least one of MIB or PBCH, Msg2, Msg4, or MsgB.

In one embodiment, the antenna 452, the transmitter 454, the transmitting processor 468, and the controller/processor 459 are used to transmit Msg1, Msg3, MsgA, or an RRCReconfigurementComplete message or an RRCConnectionReconfigurementComplete message; at least one of the antenna 420, the receiver 418, the receiving processor 470, or the controller/processor 475 is used to receive Msg1 or Msg3 or MsgA or an RRCReconfigurementComplete message or an RRCConnectionReconfigurementComplete message.

In one embodiment, the first communication device 450 corresponds to a first node in the present application.

In one embodiment, the first communication device 450 corresponds to a second node in the present application.

In one embodiment, the first communication device 450 is a UE.

In one embodiment, the first communication device 450 is a base station (gNB/eNB/ng-eNB).

In one embodiment, the first communication device 450 is a UE that supports large delay differences.

In one embodiment, the first communication device 450 is a UE that supports NTN.

In one embodiment, the first communication device 450 is an aircraft device.

In one embodiment, the first communication device 450 has a positioning capability.

In one embodiment, the first communication device 450 does not have a positioning capability.

In one embodiment, the first communication device 450 is a UE that supports TN.

In one embodiment, the second communication device 410 is a UE.

In one embodiment, the second communication device 410 is a base station.

In one embodiment, the second communication device 410 is a base station that supports large delay differences.

In one embodiment, the second communication device 410 is a base station that supports NTN.

In one embodiment, the second communication device 410 is satellite equipment.

In one embodiment, the second communication device 410 is flying platform equipment.

In one embodiment, the second communication device 410 is a base station that supports TN.

### Embodiment 5C

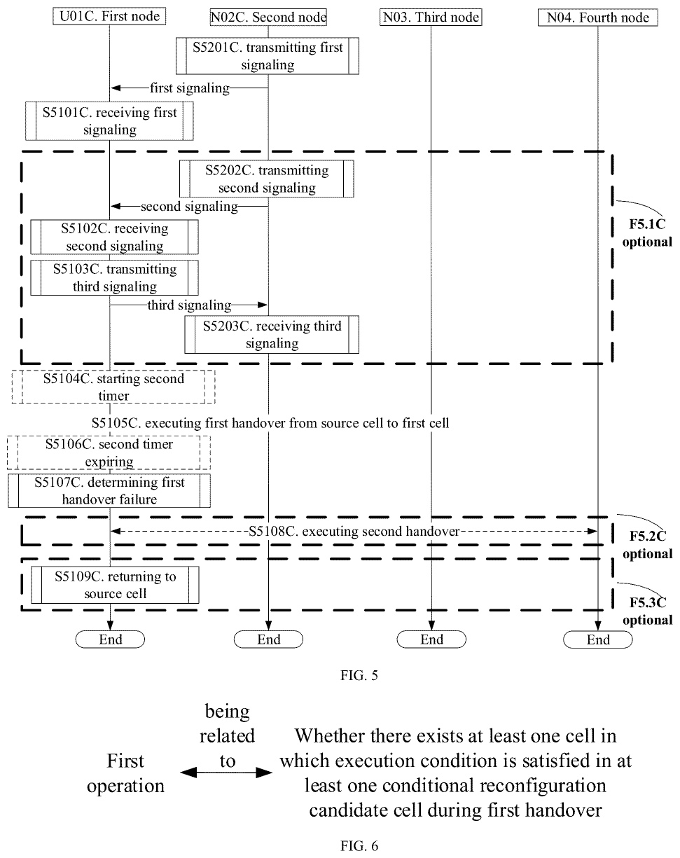

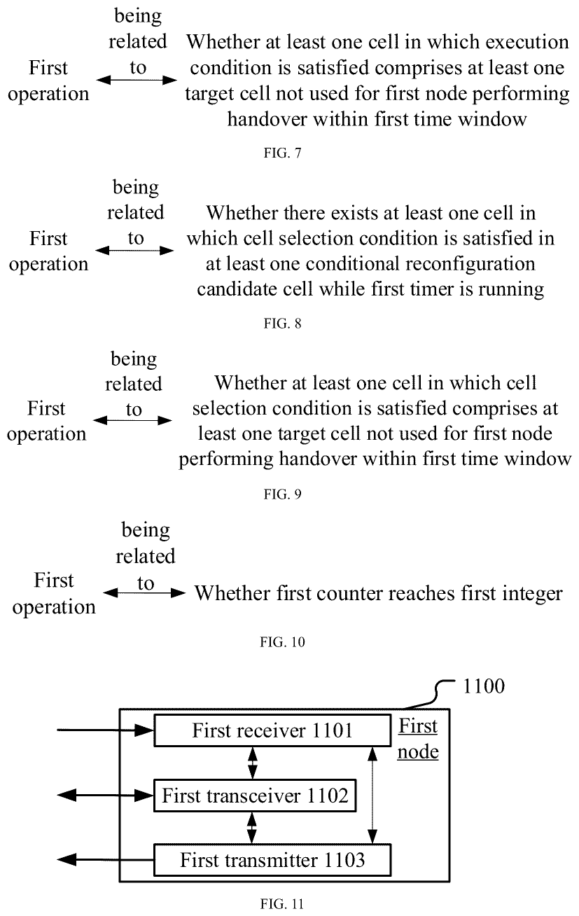

Embodiment 5C illustrates a flowchart of radio signal transmission according to one embodiment in the present application, as shown in FIG. 5. It is particularly underlined that the order illustrated in the embodiment does not put constraints over sequences of signal transmissions and implementations.

The first node U01C receives a first signaling in step S5101C, and the first signaling indicates a configuration of a first cell; in step S5102C, receives a second signaling, the second signaling indicates a configuration of each cell in the at least one conditional reconfiguration candidate cell; in step S5102C, transmits a third signaling, the third signaling is triggered by the second signaling; in step S5104C, starts a second timer; in step S5105C, executes a first handover from a source cell to the first cell; in step S5106C, the second timer expires; in step S5107C, determines first handover failure; in step S5108C, as a response to the behavior of determining first handover failure, executes a first operation, and the first operation is executing a second handover; in step S5109C, as a response to the behavior of determining first handover failure, executes a first operation, and the first operation is returning to the source cell.

The second node N02C transmits the first signaling in step S5201; in step S5202C, transmits the second signaling; in step S5203C, receives the third signaling.

The third node N03 transmits at least one of MIB, PBCH, Msg2, Msg4, or MsgB in the step S5105C; receives at least one of Msg1, Msg3, MsgA, an RRCReconfigurementComplete message or an RRCConnectionReconfigurementComplete message.

The fourth node N04 transmits at least one of MIB, PBCH, Msg2, Msg4, or MsgB in the step S5108C; receives at least one of Msg1, Msg3, MsgA, an RRCReconfigurementComplete message or an RRCConnectionReconfigurementComplete message.

In embodiment 5C, the behavior of executing a first handover from a source cell to the first cell comprises applying the configuration of the first cell; the first operation is a candidate operation in a first candidate operation set, and the first candidate operation set comprises at least two candidate operations of returning to the source cell and executing a second handover; the first operation is related to at least whether the first node U01C is configured with at least one conditional reconfiguration candidate cell; when the first node U01C is not configured with a conditional reconfiguration candidate cell, the first operation is returning to the source cell.

In on embodiment, the first node U01C receives at least one of MIB, PBCH, Msg2, Msg4, or MsgB in the procedure of step S5105C; transmits at least one of Msg1, Msg3, MsgA, an RRCReconfigurementComplete message or an RRCConnectionReconfigurementComplete message.

In on embodiment, the first node U01C receives at least one of MIB, PBCH, Msg2, Msg4, or MsgB in the procedure of step S5108C; transmits at least one of Msg1, Msg3, MsgA, an RRCReconfigurementComplete message or an RRCConnectionReconfigurementComplete message.

In one embodiment, the third node N03 comprises a maintenance base station of the first cell.

In one embodiment, the fourth node N04 is a maintenance base station of the second cell.

In one embodiment, the third node N03 is the same as the fourth node N04.

In one embodiment, the third node N03 is different from the fourth node N04.

In one embodiment, the third node N03 is the same as the second node N02C.

In one embodiment, the third node N03 is different from the second node N02C.

In one embodiment, the second node N02C is a maintenance base station of the source cell.

In one embodiment, the first node U01C is a UE.

In one embodiment, the first node U01C is a relay device.

In one embodiment, the first node U01C is an IoT device.

In one embodiment, the first node U01C is a testing device.

In one embodiment, the second node N02C is a base station device.

In one embodiment, the second node N02C is a relay device.

In one embodiment, the third node N03 is a base station.

In one embodiment, the third node N03 is a relay.

In one embodiment, the fourth node N04 is a base station.

In one embodiment, the fourth node N04 is a relay.

In one embodiment, the second node N02C is a base station, the third node N03 is a base station, and the fourth node N04 is a base station.

In one embodiment, the second node N02C is a base station, the third node N03 is a base station, and the fourth node N04 is a relay device.

In one embodiment, the second node N02C is a base station, the third node N03 is a relay, and the fourth node N04 is a relay device.

In one embodiment, the second node N02C is a base station, the third node N03 is a relay device, and the fourth node N04 is a base station.

In one embodiment, the second node N02C is a relay device, the third node N03 is a relay device, and the fourth node N04 is a relay device.

In one embodiment, the second node N02C is a relay device, the third node N03 is a base station, and the fourth node N04 is a relay device.

In one embodiment, the second node N02C is a relay device, the third node N03 is a relay device, and the fourth node N04 is a base station.

In one embodiment, the second node N02C is a relay device, the third node N03 is a base station, and the fourth node N04 is a base station.

In one embodiment, the second signaling is a downlink (DL) message.

In one embodiment, the second signaling is a sidelink message.

In one embodiment, the second signaling is transmitted through SRB1.

In one embodiment, the second signaling is transmitted through SRB3.

In one embodiment, the second signaling is transmitted on a DCCH.

In one embodiment, the second signaling is an RRC-layer message.

In one embodiment, the second signaling is used for configuring for a conditional reconfiguration.

In one embodiment, the second signaling is used for configuring for a CHO.

In one embodiment, the second signaling is used for configuring for a CPC.

In one embodiment, the second signaling is used for configuring for conditional reconfiguration based handover.

In one embodiment, the second signaling comprises at least one RRC message.

In one embodiment, the second signaling comprises an RRCReconfiguration message.

In one embodiment, the second signaling comprises an RRCConnectionReconfiguration message.

In one embodiment, the second signaling comprises an RRC IE, and a name of the RRC IE comprises CellGroupConfig.

In one embodiment, the second signaling comprises an RRC IE, and a name of the RRC IE comprises ServingCellConfigCommon.

In one embodiment, the second signaling comprises an RRC IE, and a name of the RRC IE comprises RACH-ConfigDedicated.

In one embodiment, the second signaling comprises an RRC IE, and a name of the RRC IE comprises RACH-ConfigDedicated.

In one embodiment, the second signaling comprises an RRC field, and a name of the RRC field comprises ReconfigurementWithSync.

In one embodiment, the second signaling comprises an RRC field, and a name of the RRC field comprises mobilityControlInfo.

In one embodiment, the second signaling comprises an RRC field, and a name of the RRC field comprises MobilityControlInfoSCG.

In one embodiment, the second signaling comprises an RRC field, and a name of the RRC field comprises SpCellConfig.

In one embodiment, the second signaling comprises an RRC field, and a name of the RRC field comprises masterCellGroup.

In one embodiment, the second signaling comprises an RRC field, and a name of the RRC field comprises secondaryCellGroup.

In one embodiment, the second signaling comprises an RRC IE, and a name of the RRC IE comprises ConditionalReconfiguration.

In one embodiment, the second signaling comprises an RRC IE, and a name of the RRC IE comprises CondReconfigToAddModList.

In one embodiment, the second signaling comprises an RRC IE, and a name of the RRC IE comprises CondReconfigurationToAddModList.

In one embodiment, the second signaling comprises an RRC IE, and a name of the RRC IE comprises condReconfigurationId.

In one embodiment, the second signaling comprises an RRC IE, and a name of the RRC IE comprises CondReconfigId.

In one embodiment, the second signaling comprises an RRC field, and a name of the RRC field comprises condExecutionCond.

In one embodiment, the second signaling comprises an RRC field, and a name of the RRC field comprises triggerCondition.

In one embodiment, the second signaling comprises an RRC field, and a name of the RRC field comprises condRRCReconfig.

In one embodiment, the second signaling comprises an RRC field, and a name of the RRC field comprises condReconfigurationToApply.

In one embodiment, an entry in a CondReconfigToAddMod IE in the second signaling corresponds to a candidate cell in the at least one conditional re-configuration candidate cell.

In one embodiment, an entry in a CondReconfigurationToAddModList IE in the second signaling corresponds to a candidate cell in the at least one conditional re-configuration candidate cell.

In one embodiment, one entry in an CondReconfigToAddMod IE in the second signaling comprises a CondReconfigId field, a CondExecutionCond field, and a CondRRCReconfig field, the condReconfigId field indicates a candidate cell in the at least one conditional reconfiguration candidate cell, the condExecutionCond field indicates an execution condition of the candidate cell, and the condRRCReconfig field indicates a configuration of the candidate cell.

In one embodiment, one entry in an CondReconfigurementToAddModList IE in the second signaling comprises a CondReconfigurementId field, a triggerCondition field, and a CondReconfigurementToApply field, the condReconfigurionId field indicates a candidate cell in the at least one conditional reconfiguration candidate cell, the triggerCondition field indicates an execution condition of the candidate cell, and the condReconfigurionToApply field indicates s configuration of the candidate cell.

In one embodiment, the phrase that the second signaling indicates a configuration of each cell in the at least one conditional reconfiguration candidate cell comprises: the second signaling comprises configuration information of each cell in the at least one conditional reconfiguration candidate cell.

In one embodiment, the phrase that the second signaling indicates a configuration of each cell in the at least one conditional reconfiguration candidate cell comprises: the second signaling is used to configure each cell in the at least one conditional reconfiguration candidate cell.

In one embodiment, the phrase that the second signaling indicates a configuration of each cell in the at least one conditional reconfiguration candidate cell comprises: the second signaling comprises parameters for the synchronous reconfiguration to each cell in the at least one conditional reconfiguration candidate cell.

In one embodiment, the phrase that the second signaling indicates a configuration of each cell in the at least one conditional reconfiguration candidate cell comprises: the second signaling comprises cell-specific parameters for each cell in the at least one conditional reconfiguration candidate cell.

In one embodiment, the second signaling comprises a cell identifier of each cell in the at least one conditional reconfiguration candidate cell.

In one embodiment, the second signaling comprises an identifier of the first node U01C in each cell of the at least one conditional reconfiguration candidate cell.

In one embodiment, according to whether the second signaling is received, it is determined whether the first node U01C is configured with at least one conditional reconfiguration candidate cell.

In one subembodiment of the embodiment, if the second signaling is received, the first node U01C is configured with at least one conditional reconfiguration candidate cell.

In one subembodiment of the embodiment, if the second signaling is not received, the first node U01C is not configured with at least one conditional reconfiguration candidate cell.

In one subembodiment of the embodiment, the second signaling comprises a CondReconfigurementToAddModList, and the CondReconfigurementToAddModList comprises at least one ConditionalReconfigurationId.

In one subsidiary embodiment of the subembodiment, after the second signaling is received, if condReconfigurationToRemoveList is not received, the first node U01C is configured with at least one conditional reconfiguration candidate cell.

In one subsidiary embodiment of the subembodiment, after the second signaling is received, if at least one condReconfigurementToRemoveList is received, but the at least one condReconfigurationToRemoveList does not comprise at least one in the at least one ConditionalReconfigurationId, the first node U01C is configured with at least one conditional reconfiguration candidate cell.

In one subsidiary embodiment of the subembodiment, after the second signaling is received, if at least one condReconfigurementToRemoveList is received, and the at least one condReconfigurementToRemoveList comprises all ConditionalReconfigurationIds in the at least one ConditionalReconfigurationId, the first node U01C is not configured with at least one conditional reconfiguration candidate cell.

In one subembodiment of the embodiment, the second signaling comprises a condReconfigToAddModList, and the condReconfigToAddModList comprises at least one CondReconfigId.

In one subsidiary embodiment of the subembodiment, after the second signaling is received, and if condReconfigToRemoveList is not received, the first node U01C is configured with at least one conditional reconfiguration candidate cell.

In one subsidiary embodiment of the subembodiment, after the second signaling is received, and if at least one condReconfigToRemoveList is received, but the at least one condReconfigToRemoveList does not comprise at least one in the at least one CondReconfigId, the first node U01C is configured with at least one conditional reconfiguration candidate cell.

In one subsidiary embodiment of the subembodiment, after the second signaling is received, and if at least one condReconfigToRemoveList is received, and the at least one condReconfigToRemoveList comprises all CondReconfigIds in the at least one CondReconfigId, and the first node U01C is not configured with at least one conditional reconfiguration candidate cell.

In one embodiment, the third signaling is an uplink message.

In one embodiment, the third signaling is a sidelink message.

In one embodiment, the third signaling is transmitted through SRB1.

In one embodiment, the third signaling is transmitted through SRB3.

In one embodiment, the third signaling is transmitted on a DCCH.

In one embodiment, the third signaling is an RRC-layer message.

In one embodiment, the third signaling comprises at least one RRC message.

In one embodiment, the third signaling comprises an RRCReconfigurationComplete message.

In one embodiment, the third signaling comprises an RRCConnectionReconfigurationComplete message.

In one embodiment, the third signaling is a confirmation message for the second signaling.

In one embodiment, as a response to the second signaling being received, the third signaling is transmitted.

In one embodiment, a protocol stack of a DAPS bearer is located at a maintenance base station of the source cell and a maintenance base station of a target cell during a DAPS handover period to use resources of a maintenance base station of the source cell and a maintenance base station of the target cell.

In one embodiment, the first bearer is a bearer whose protocol stack is located at the second node N02C and the third node N03 during DAPS handover period to use resources of the second node N02C and the third node N03; the first bearer is a DAPS bearer for the first cell.

In one embodiment, the second bearer is a bearer whose protocol stack is located at the second node N02C and the fourth node N04 during DAPS handover period to use resources of the second node N02C and the fourth node N04; the second bearer is a DAPS bearer for the second cell.

In one embodiment, for a DAPS bearer, a PDCP entity is associated with at least 2 UM (Unacknowledged Mode) RLC (Radio Link Control) entities.

In one embodiment, for a DAPS bearer, a PDCP entity is associated with two UM RLC entities.

In one embodiment, for a DAPS bearer, a PDCP entity is associated with four UM RLC entities.

In one embodiment, for a DAPS bearer, a PDCP entity is associated with at least 2 AM (Acknowledged Mode) RLC (Radio Link Control) entities.

In one embodiment, for a DAPS bearer, a PDCP entity is associated with two AM RLC entities.

In one embodiment, for a DAPS bearer, a PDCP entity is associated with four AM RLC entities.

In one embodiment, a first bearer is configured, and the first bearer is a DAPS bearer for the first cell.

In one embodiment, the first signaling is used to indicate that the first bearer is configured.

In one embodiment, the first signaling comprises a DRB-ToAddMod field, the DRB-ToAddMod field comprises a drb-Identity field and a daps-Config field, a value of the drb-Identity field is set as an identifier of a DRB, a value of the daps-Config field is set as ture, and the first bearer is the DRB.

In one embodiment, the first signaling comprises a DRB-ToAddMod field, the DRB-ToAddMod field comprises a drb-Identity field and a daps-HO field, a value of the drb-Identity field is set as an identifier of a DRB, a value of the daps-HO field is set as ture, and the first bearer is the DRB.

In one embodiment, the first signaling indicates that at least one DRB is configured as a DAPS bearer for the first cell, and the first bearer is any DRB in the at least one DRB.

In one embodiment, if the first bearer is configured, as a response to the behavior of determining first handover failure, performing at least one of the following behaviors:
resetting a MAC for the first cell and releasing a MAC configuration for the first cell;
for the first bearer, releasing an RLC entity and a related logical channel for the first cell;
for the first bearer, reconfiguring a DAPS entity to release a DAPS;
for each SRB, releasing a PDCP entity for the first cell;
for each SRB, releasing an RLC entity and a related logical channel for the first cell;
for each SRB, triggering an execution of an SDU (Service Data Unit) discard for a PDCP entity of the source cell;
for each SRB, reconstructing an RLC entity for the first cell;
releasing a physical channel configuration for the first cell;
if a key in the first cell is configured, discarding a key in the first cell.

In one embodiment, if the first bearer is configured, the behavior of executing a first handover from a source cell to the first cell also comprises at least one of the following behaviors:
creating a MAC entity of a cell group to which the first cell belongs with a same configuration as a MAC entity configuration in a cell group to which the source cell belongs;
for the first bearer, establishing an RLC entity in a cell group to which the first cell belongs with a same configuration as an RLC entity in a cell group to which the source cell belongs, and for the first bearer, establishing a logical channel in a cell group to which the first cell belongs with a same configuration as a logical channel in a cell group to which the source cell belongs;
for each SRB, establishing an RLC entity in a cell group to which the first cell belongs with a same configuration as an RLC entity in a cell group to which the source cell belongs, and for the first bearer, establishing a logical channel in a cell group to which the first cell belongs with a same configuration as a logical channel in a cell group to which the source cell belongs;
suspending an SRB of a cell group to which the source cell belongs.

In one embodiment, the behavior of executing a second handover comprises: if at least one DAPS bearer for the second cell is configured, creating a MAC entity for the cell group to which the first serving cell belongs with a same configuration as a MAC entity for a cell group to which the first serving cell belongs.

In one embodiment, the behavior of executing a second handover comprises: if at least one DAPS bearer for the second cell is configured, for the first bearer, establishing an RLC entity in a cell group to which the first cell belongs with a same configuration as an RLC entity in a cell group to which the first serving cell belongs, and, for the first bearer, establishing a logical channel in a cell group to which the first serving cell belongs with a same configuration as a logical channel in a cell group to which the first serving cell belongs;

In one embodiment, the behavior of executing a second handover comprises: if at least one DAPS bearer for the second cell is configured, for each SRB, establishing an RLC entity in a cell group to which the first cell belongs with a same configuration as an RLC entity in a cell group to which the first serving cell belongs, and for the first bearer, establishing a logical channel in a cell group to which the first serving cell belongs with a same configuration as a logical channel in a cell group to which the first serving cell belongs.

In one embodiment, the behavior of executing a second handover comprises: if at least one DAPS bearer for the second cell is configured, suspending an SRB of the first cell group.

In one embodiment, if at least one DAPS bearer for the second cell is configured, the behavior of executing a second handover also comprises at least one of the following behaviors:
creating a MAC entity of a cell group to which the second cell belongs with a same configuration as a MAC entity in a cell group to which the source cell belongs;
if the first bearer is configured, for each DAPS bearer in the at least one DAPS bearer of the second cell, establishing an RLC entity in a cell group to which the second cell belongs with a configuration as an RLC entity in a cell group to which the source cell belongs, and for each DAPS bearer in the at least one DAPS bearer in the second cell, establishing a logical channel in a cell group to which the second cell belongs with a same configuration as a logical channel in a cell group to which the source cell belongs.
if the first bearer is configured, for each SRB, establishing an RLC entity in a cell group to which the second cell belongs with a configuration as an RLC entity in a cell group to which the source cell belongs, and, for the first bearer, establishing a logical channel in a cell group to which the second cell belongs with a configuration as a logical channel in a cell group to which the source cell belongs;
if the first bearer is configured, suspending an SRB of a cell group to which the source cell belongs.

In one embodiment, during the first handover, no radio link failure (RLF) occurs in the source cell.

In one embodiment, no radio link failure occurring in the source cell during the first handover comprises: during the first handover, a T310 of the source cell does not expire.

In one embodiment, no radio link failure occurring in the source cell during the first handover comprises: during the first handover, no random access problem indication is received from the MAC of a cell group in the source cell.

In one embodiment, no radio link failure occurring in the source cell during the first handover comprises: during the first handover, no indication of the maximum number of retransmissions of RLCs from the cell group in the source cell has been reached.

In one embodiment, no radio link failure occurring in the source cell during the first handover comprises: during the first handover, no consistent uplink LBT (Listen Before Talk) failure indication is received from a MAC of the cell group in the source cell.

In one embodiment, no radio link failure occurring in the source cell during the first handover comprises: during the first handover, no RLF of a cell group to which the source cell belongs is detected.

In one embodiment, a first bearer is configured, and the first bearer is a DAPS bearer for the first cell; during the first handover, no radio link failure (RLF) occurs in the source cell.

In one embodiment, the step S5104C is optional.

In one embodiment, the step S5104C exists.

In one embodiment, the step S5104C does not exist.

In one embodiment, the step S5106C is optional.

In one embodiment, the step S5106C exists.

In one embodiment, the step S5106C does not exist.

In one embodiment, both step S5104C and step S5106C exist.

In one embodiment, both step S5104C and step S5106C do not exist.

In one embodiment, the dotted box F5.1C is optional.

In one embodiment, the dotted box F5.1C exists.

In one subembodiment of the above embodiment, the at least one conditional reconfiguration candidate cell is configured.

In one subembodiment of the above embodiment, the second signal is received, and the third signaling is transmitted.

In one embodiment, the dotted box F5.1C does not exist.

In one subembodiment of the above embodiment, the at least one conditional reconfiguration candidate cell is not configured.

In one subembodiment of the above embodiment, the second signal is not received, and the third signaling is not transmitted.

In one embodiment, the dotted box F5.2C is optional.

In one embodiment, the dotted box F5. 2C exists.

In one embodiment, the dotted box F5. 2C does not exist.

In one embodiment, the dotted box F5. 3C is optional.

In one embodiment, the dotted box F5. 3C exists.

In one embodiment, the dotted box F5. 3C does not exist.

In one embodiment, one of the dotted boxes F5. 2C and F5. 3C exists.

In one embodiment, the dotted boxes F5. 2C and F5. 3C do not exist at the same time.

### Embodiment 6C

Embodiment 6C illustrates a schematic diagram of a first operation being related to whether there exists at least one cell in which an execution condition is satisfied in at least one conditional reconfiguration candidate cell during a first handover period according to one embodiment of the present application, as shown in FIG. 6.

In embodiment 6C, the first node is configured with at least one conditional reconfiguration candidate cell; the first operation is related to whether there exists at least one cell in which an execution condition is satisfied in the at least one conditional reconfiguration candidate cell during the first handover; when there does not exist a cell in which an execution condition is satisfied in the at least one conditional reconfiguration candidate cell during the first handover, the first operation is returning to the source cell.

In one embodiment, the first node is configured with at least one conditional reconfiguration candidate cell; the first operation is related to whether there exists at least one cell in which an execution condition is satisfied in a last measurement result during the first handover in the at least one conditional reconfiguration candidate cell; when there does not exist a cell in which an execution condition is satisfied in a last measurement result in the first handover period in the at least one conditional reconfiguration candidate cell, the first operation is returning to the source cell.

In one embodiment, the first node is configured with at least one conditional reconfiguration candidate cell; the first operation is related to whether there exists at least one cell in which an execution condition is satisfied in any measurement result during the first handover in the at least one conditional reconfiguration candidate cell; when there does not exist a cell in which an execution condition is satisfied in any measurement result in the first handover period in the at least one conditional reconfiguration candidate cell, the first operation is returning to the source cell.

In one embodiment, the there exists no cell in which an execution condition is satisfied in the at least one conditional reconfiguration candidate cell in the first handover period comprises: determining that there exists no cell in which an execution condition is satisfied in the at least one conditional reconfiguration candidate cell according to a last measurement result in the first handover period.

In one embodiment, the there exists no cell in which an execution condition is satisfied in the at least one conditional reconfiguration candidate cell in the first handover period comprises: determining that there exists no cell in which an execution condition is satisfied in the at least one conditional reconfiguration candidate cell according to any measurement result in the first handover period.

In one embodiment, the first node evaluates for an execution condition of the at least one condition re-configuration candidate cell during the first handover.

In one embodiment, the phrase that the first operation is related to whether there exists at least one cell in which an execution condition is satisfied in the at least one conditional reconfiguration candidate cell during the first handover comprises: whether there exists at least one cell in which an execution condition is satisfied in the at least one conditional reconfiguration candidate cell during the first handover is used to determine the first operation.

In one embodiment, the phrase that the first operation is related to whether there exists at least one cell in which an execution condition is satisfied in the at least one conditional reconfiguration candidate cell during the first handover comprises: whether there exists at least one cell in which an execution condition is satisfied in the at least one conditional reconfiguration candidate cell during the first handover is used to whether to return to the source cell.

In one embodiment, when there exists at least one cell in which an execution condition is satisfied in the at least one conditional reconfiguration candidate cell in the first handover period, the first operation is not returning to the source cell.

In one embodiment, when there exists at least one cell in which an execution condition is satisfied in the at least one conditional reconfiguration candidate cell in the first handover period, the first operation is executing the second handover.

In one embodiment, the first handover period comprises that the second timer is running.

In one embodiment, the first handover period refers to while the second timer is running.

In one embodiment, whether implementation conditions are satisfied is determined according to section 5.3.5.13.4 of 3GPP TS 38.331.

In one embodiment, triggering events associated with a measurement identifier associated with an execution condition for a candidate cell are all satisfied, it is considered that the candidate cell is a triggering cell.

In one embodiment, if there is only one triggering cell, the triggering cell is a selected cell.

In one embodiment, if there exist at least two triggering cells, the first node selects a triggering cell as a selected cell.

In one embodiment, if there exist at least two triggering cells, one of the at least two triggering cells is a selected cell.

In one embodiment, if there exist at least two triggering cells, and there exist at least one triggering cell configured with a DAPS bearer and at least one triggering cell not configured with a DAPS bearer, a cell determined in the at least one triggering cell not configured with a DAPS bearer is a selected cell.

In one embodiment, if there only exists one cell in which an execution condition is satisfied, the cell in which an execution condition is satisfied is a target cell for the second handover.

In one embodiment, if there exist at least two cells in which execution conditions are satisfied, the first node selects one in the at least two cells in which execution conditions are satisfied as a target cell for the second handover.

In one embodiment, the execution condition refers to an execution condition for a reconfiguration candidate cell.

In one embodiment, each candidate cell in the at least one conditional reconfiguration candidate cell is configured with an execution condition.

In one embodiment, for any candidate cell in the at least one conditional reconfiguration candidate cell, whether an execution condition for the any candidate cell is satisfied is evaluated.

In one embodiment, the execution condition is related to at least one of an RSRP (Reference Signal Received Power) measurement result, or an RSRQ (Reference Signal Received Quality) measurement result, or an SINR (Signal to Interference plus Noise Ratio) measurement result.

In one embodiment, the execution condition comprises an Entering condition for Event A3 in 3GPP TS 38.331.

In one embodiment, the execution condition comprises an Entering condition for Event A5 in 3GPP TS 38.331.

In one embodiment, the execution condition is associated to at least one measurementId, and the at least one measurementId is associated to at least one of the A3 event or the A5 event.

In one embodiment, whether there exists at least one cell in which an execution condition is satisfied is determined only in the at least one conditional reconfiguration candidate cell.

### Embodiment 7C

Embodiment 7C illustrates a schematic diagram of a first operation being related to at least whether one cell in which an execution condition is satisfied comprises at least one target cell not used for the first node performing handover within a first time window according to one embodiment of the present application.

In embodiment 7C, the first node is configured with at least one conditional reconfiguration candidate cell, there exists at least one cell in which an execution condition is satisfied in the at least one conditional reconfiguration candidate cell during the first handover, and the first operation is related to whether the at least one cell in which an execution condition is satisfied comprises at least one target cell not used for the first node performing handover within a first time window; when the at least one cell in which an execution condition is satisfied does not comprise a target cell not used for the first node performing handover within a first time window, the first operation is returning to the source cell; when the at least one cell in which an execution condition is satisfied comprises a target cell not used for the first node performing handover within a first time window, the first operation is executing the second handover.

In one embodiment, the there exists at least one cell in which an execution condition is satisfied in the at least one conditional reconfiguration candidate cell in the first handover period comprises: determining that there exists at least one cell in which an execution condition is satisfied in the at least one conditional reconfiguration candidate cell according to a last measurement result in the first handover period.

In one embodiment, the there exists at least one cell in which an execution condition is satisfied in the at least one conditional reconfiguration candidate cell in the first handover period comprises: determining that there exists at least one cell in which an execution condition is satisfied in the at least one conditional reconfiguration candidate cell according to any measurement result in the first handover period.

In one embodiment, the phrase that the first operation is related to whether the at least one cell in which an execution condition is satisfied comprises at least one target cell not used for the first node performing handover within a first time window comprises: whether the at least one cell in which an execution condition is satisfied comprises at least one target cell not used for the first node performing handover within the first time window is used to determine the first operation.

In one embodiment, the phrase that the first operation is related to whether the at least one cell in which an execution condition is satisfied comprises at least one target cell not used for the first node performing handover within a first time window comprises: whether the at least one cell in which an execution condition is satisfied comprises at least one target cell not used for the first node performing handover within the first time window is used to determine whether the second handover is executed.

In one embodiment, the phrase that the first operation is related to whether the at least one cell in which an execution condition is satisfied comprises at least one target cell not used for the first node performing handover within a first time window comprises: whether the at least one cell in which an execution condition is satisfied comprises at least one target cell not used for the first node performing handover within the first time window is used to determine whether to return to the source cell or execute the second handover.

In one embodiment, the phrase that the first operation is related to whether the at least one cell in which an execution condition is satisfied comprises at least one target cell not used for the first node performing handover within a first time window comprises: the first operation is related to whether the first time window is running.

In one subembodiment of the embodiment, if the first time window is running, the first operation is returning to the source cell.

In one subembodiment of the embodiment, if the first time window is not running, the first operation is executing the second handover.

In one embodiment, the phrase that the first operation is related to whether the at least one cell in which an execution condition is satisfied comprises at least one target cell not used for the first node performing handover within a first time window comprises: the first operation is related to whether the at least one cell in which an execution condition is satisfied comprises at least one cell in which the first time window is not running.

In one subembodiment of the embodiment, when the at least one cell in which an execution condition is satisfied does not comprise a cell in which the first time window is not running, the first operation is returning to the source cell.

In one subembodiment of the embodiment, when the at least one cell in which an execution condition is satisfied comprises a cell in which the first time window is not running, the first operation is executing the second handover.

In one embodiment, the first time window is configured for the second cell.

In one embodiment, the first time window is configured for each cell in the at least one conditional reconfiguration candidate cell.

In one embodiment, the first time window comprises a positive integer number of millisecond(s).

In one embodiment, the first time window comprises a positive integer number of slot(s).

In one embodiment, the first time window comprises a timer.

In one embodiment, the first time window is a timer.

In one embodiment, the first time window is pre-configured.

In one embodiment, the first time window is configurable.

In one embodiment, the first time window is for the second cell.

In one embodiment, the first time window is for any cell in the at least one condition reconfiguration candidate cell.

In one embodiment, the first time window is for all cells in the at least one condition reconfiguration candidate cell.

In one embodiment, while the first time window is running, the second cell is not used for a target cell in which the first node performs handover.

In one embodiment, while the first time window is running, the second cell is not used for CHO handover.

In one embodiment, while the first time window is running, the first node does not evaluate an execution condition of the second cell.

In one embodiment, while the first time window is running, the first node evaluates an execution condition of each candidate cell other than the second cell in the at least one conditional reconfiguration candidate cell.

In one embodiment, while the first time window is running, each cell in the at least one conditional reconfiguration candidate cell is not used for a target cell in which the first node performs handover.

In one embodiment, while the first time window is running, each cell in the at least one conditional reconfiguration candidate cell is not used for CHO handover.

In one embodiment, while the first time window is running, the first node does not evaluate for an execution condition of the at least one conditional reconfiguration candidate cell.

In one embodiment, while the first time window is running, the second cell is not used for triggering a cell.

In one embodiment, while the first time window is running, the second cell is not used for selecting a cell.

In one embodiment, the second cell being used for a target cell in which the first node performs handover is used to determine starting the first time window.

In one embodiment, any cell in the at least one conditional reconfiguration candidate cell being used for a target cell in which the first node performing handover is used to determine starting the first time window.

In one embodiment, if the first time window is not running, the second cell can be used as a target cell in which the first node performs handover.

In one embodiment, if the first time window is not running, each cell of the at least one conditional reconfiguration candidate cell can be used as a target cell in which the first node performs handover.

In one embodiment, if a configuration of the second cell is released, the first time window is stopped.

In one embodiment, if a configuration of the second cell is released, it is considered that the first time window expires.

In one embodiment, if a configuration of the second cell is released, the first time window is released.

In one embodiment, if a configuration of the second cell is released, the first time window is reset.

In one embodiment, if a configuration of the second cell is reconfigured, the first time window is stopped.

In one embodiment, if a configuration of the second cell is reconfigured, the first time window is reconfigured.

In one embodiment, if a configuration of the second cell is reconfigured, the first time window is reconfigured and stopped.

In one embodiment, if a configuration of the at least one condition reconfiguration candidate cell is released, the first time window is stopped.

In one embodiment, if a configuration of the at least one condition reconfiguration candidate cell is released, it is considered that the first time window expires.

In one embodiment, if a configuration of the at least one condition reconfiguration candidate cell is released, the first time window is released.

In one embodiment, if a configuration of the at least one condition reconfiguration candidate cell is released, the first time window is reset.

### Embodiment 8C

Embodiment 8C illustrates a schematic diagram of a first operation being related to whether there exists at least one cell in which a cell selection condition is satisfied in at least one condition reconfiguration candidate cell while a first timer is running according to one embodiment of the present application.

In embodiment 8C, the first node is configured with at least one conditional reconfiguration candidate cell; the first operation is related to whether there exists at least one cell in which a cell selection condition is satisfied in the at least one condition reconfiguration candidate cell while a first timer is running; when there does not exist a cell in which a cell selection condition is satisfied in the at least one conditional reconfiguration candidate cell while the first timer is running, the first operation is returning to the source cell; an expiration of the first timer is used to determine that there does not exist a cell in which a cell selection condition is satisfied.

In one embodiment, the phrase that the first operation is related to whether there exists a cell in which at least one cell selection condition is satisfied in the at least one conditional reconfiguration candidate cell while a first timer is running comprises: whether there exists a cell in which at least one cell selection condition is satisfied in the at least one conditional reconfiguration candidate cell while the first timer is running is used to determine the first operation.

In one embodiment, the phrase that the first operation is related to whether there exists a cell in which at least one cell selection condition is satisfied in the at least one conditional reconfiguration candidate cell while a first timer is running comprises: whether there exists a cell in which at least one cell selection condition is satisfied in the at least one conditional reconfiguration candidate cell while the first timer is running is used to determine whether to return to the source cell

In one embodiment, when there exists at least one cell in which a cell selection condition is satisfied in the at least one conditional reconfiguration candidate cell while the first timer is running, the first operation is not returning to the source cell.

In one embodiment, when there exists at least one cell in which a cell selection condition is satisfied in the at least one conditional reconfiguration candidate cell while the first timer is running, the first operation is executing the second handover.

In one embodiment, the first timer is started in the procedure of RRC connection re-establishment.

In one embodiment, the first timer is not started in the procedure of RRC connection re-establishment.

In one embodiment, the first timer is T311.

In one embodiment, the first timer is an RRC-layer timer.

In one embodiment, the first timer is a new timer.

In one embodiment, as a response to the behavior of determining first handover failure, start the first timer.

In one embodiment, as a response to the behavior of determining first handover failure, initiate an RRC connection re-establishment procedure, and as a response to initiating an RRC connection re-establishment procedure, initiate the first timer.

In one embodiment, as a response to determining that there exists a cell in which a cell selection condition is satisfied, stop the first timer.

In one embodiment, if it is determined that there exists a cell in which a cell selection condition is satisfied, stop the first timer.

In one embodiment, when it is determined that there exists a cell in which a cell selection condition is satisfied, stop the first timer.

In one embodiment, when it is determined that there exists a cell in which a cell selection condition is satisfied, stop the first timer.

In one embodiment, an expiration of the first timer is used to determine that there does not exist a cell in which a cell selection condition is satisfied in the at least one conditional reconfiguration candidate cell while the first timer is running.

In one embodiment, the first timer being expired refers to that a running time of the first timer reaches an expiration time of the first timer.

In one embodiment, the first timer being expired refers to that a timing of the first timer reaches an expiration time of the first timer.

In one embodiment, an expiration value of the first timer is configurable.

In one embodiment, an expiration value of the first timer is pre-configured.

In one embodiment, an expiration value of the first timer is configured through an RRC message.

In one embodiment, an expiration value of the first timer is equal to a positive integer number of millisecond(s).

In one embodiment, if there only exists a cell in which a cell selection condition is satisfied, a cell in which the cell selection condition is satisfied is a target cell for the second handover.

In one embodiment, if there exist at least two cells in which a cell selection condition is satisfied, the first node selects one of the at least two cells in which a cell selection condition is satisfied as a target cell for the second handover.

In one embodiment, the cell selection condition refers to a criterion for cell selection.

In one embodiment, the cell selection condition is not a criterion for cell selection.

In one embodiment, the cell selection criteria refer to an execution condition for a conditional reconfiguration candidate cell.

In one embodiment, the cell selection condition is not an execution condition for a conditional reconfiguration candidate cell.

In one embodiment, the cell selection condition is related to at least one of an RSRP measurement result, or an RSRQ measurement result, or an SINR measurement result.

In one embodiment, the cell selection condition comprises an entering condition for Event A4 in 3GPP TS 38.331.

In one embodiment, the cell selection condition comprises an entering condition for Event A4 in 3GPP TS 36.331.

In one embodiment, the cell selection condition is associated to a measurementId, and the measurementId is associated to the A4 event.

In one embodiment, while the first timer is running, execute a cell selection.

In one subembodiment of the above embodiment, execute a cell selection according to 3GPP TS 38. 304.

In one subembodiment of the above embodiment, execute a cell selection according to 3GPP TS 36. 304.

In one embodiment, while the first timer is running, evaluate the at least one conditional reconfiguration candidate cell.

In one embodiment, while the first timer is running, there exists at least one cell in which a cell selection condition is satisfied.

In one embodiment, while the first timer is running, there does not exist a cell in which a cell selection condition is satisfied.

In one embodiment, whether there exists at least one cell in which a cell selection condition is satisfied is determined only in the at least one conditional reconfiguration candidate cell.

In one embodiment, whether there exists at least one cell in which a cell selection condition is satisfied is determined in the at least one conditional reconfiguration candidate cell and at least one cell other than the at least one conditional reconfiguration candidate cell.

### Embodiment 9C

Embodiment 9C illustrates a schematic diagram of a first operation being related to at least whether one cell in which a cell selection condition is satisfied comprises at least one target cell not used for a receiver of a first signaling performing handover within a first time window according to one embodiment of the present application, as shown in FIG. 9.

In embodiment 9C, the first node is configured with at least one conditional reconfiguration candidate cell, there exists at least one cell in which a cell selection condition is satisfied in the at least one conditional reconfiguration candidate cell while the first timer is running, and the first operation is related to whether the at least one cell in which a cell selection condition is satisfied comprises at least one target cell not used for the first node performing handover within a first time window; when the at least one cell in which a cell selection condition is satisfied does not comprise a target cell not used for the first node performing handover within a first time window, the first operation is returning to the source cell; when the at least one cell in which a cell selection condition is satisfied comprises a target cell not used for the first node performing handover within a first time window, the first operation is executing the second handover.

In one embodiment, the phrase that the first operation is related to at least whether one cell in which a cell selection condition is satisfied comprises at least one target cell not used for the first node performing handover within a first time window comprises: at least whether one cell in which a cell selection condition is satisfied comprises at least one target cell not used for the first node performing handover within the first time window is used to determine the first operation.

In one embodiment, the phrase that the first operation is related to at least whether one cell in which a cell selection condition is satisfied comprises at least one target cell not used for the first node performing handover within a first time window comprises: at least whether one cell in which a cell selection condition is satisfied comprises at least one target cell not used for the first node performing handover within the first time window is used to determine whether the second handover is executed.

In one embodiment, the phrase that the first operation is related to at least whether one cell in which a cell selection condition is satisfied comprises at least one target cell not used for the first node performing handover within a first time window comprises: at least whether one cell in which a cell selection condition is satisfied comprises at least one target cell not used for the first node performing handover within the first time window is used to determine whether the first operation is returning to the source cell or executing the second handover.

In one embodiment, the phrase that the first operation is related to at least whether one cell in which a cell selection condition is satisfied comprises at least one target cell not used for the first node performing handover within a first time window comprises: the first operation is related to whether the first time window is running.

In one subembodiment of the embodiment, if the first time window is running, the first operation is returning to the source cell.

In one subembodiment of the embodiment, if the first time window is not running, the first operation is executing the second handover.

In one embodiment, the phrase that the first operation is related to at least whether one cell in which a cell selection condition is satisfied comprises at least one target cell not used for the first node performing handover within a first time window comprises: the first operation is related to whether the at least one cell in which an execution condition is satisfied comprises at least one cell in which the first time window is not running.

In one subembodiment of the embodiment, when the at least one cell in which a cell selection condition does not comprise a cell in which the first time window is not running, the first operation is returning to the source cell.

In one subembodiment of the embodiment, when the at least one cell in which a cell selection condition is satisfied comprises a cell in which the first time window is not running, the first operation is executing the second handover.

### Embodiment 10C

Embodiment 10C illustrates a schematic diagram of a first operation being related to whether a first counter reaches a first integer according to one embodiment of the present application, as shown in FIG. 10.

In embodiment 10C, the first node is configured with at least one conditional reconfiguration candidate cell, the first operation is related to whether a first counter reaches a first integer; when the first counter does not reach the first integer, the first operation is returning to the source cell; if the first operation is returning to the source cell, the first counter is incremented by 1.

In one embodiment, the phrase that the first operation is related to whether a first counter reaches a first integer comprises: whether the first counter reaches the first integer is used to determine whether to return to the source cell.

In one embodiment, the phrase that the first operation is related to whether a first counter reaches a first integer comprises: whether the first counter reaches the first integer is used to determine the first operation.

In one embodiment, when the first counter reaches the first integer, the first operation is not returning to the source cell.

In one embodiment, when the first counter reaches the first integer, the first operation is executing the second handover.

In one embodiment, when the first counter reaches the first integer, the first operation is executing an RRC connection re-establishment.

In one embodiment, when the first counter reaches the first integer, the first operation is entering into RRC_IDLE state.

In one embodiment, whenever returning to the source cell is executed, the first counter is incremented by 1.

In one embodiment, if the first node is configured with the at least one conditional reconfiguration candidate cell, whenever an execution of handover from the source cell to one of the at least one conditional reconfiguration candidate cell fails, and if returning to the source cell is executed, the first counter is incremented by 1.

In one embodiment, if the first node is configured with the at least one conditional reconfiguration candidate cell, and whenever an execution of handover failure from the source cell to a given cell fails, and if returning to the source cell is executed, the first counter is incremented by 1.

In one subembodiment of the embodiment, the given cell is a conditional reconfiguration candidate cell in the at least one conditional reconfiguration candidate cell.

In one subembodiment of the embodiment, the given cell is not a conditional reconfiguration candidate cell in the at least one conditional reconfiguration candidate cell.

In one embodiment, if it is the first time returning to the source cell, the first counter is not incremented by 1.

In one embodiment, if it is the first time returning to the source cell, the first counter is incremented by 1.

In one embodiment, the first counter is used to determine a number of time(s) of returning to the source cell.

In one embodiment, the first counter is used to determine a number of time(s) of returning to a source cell after DAPS handover failure.

In one embodiment, a value of the first counter is a non-negative integer.

In one embodiment, the first integer is configured through an RRC message.

In one embodiment, the first integer is pre-configured.

In one embodiment, the first integer is configurable.

In one embodiment, the first integer is a positive integer.

In one embodiment, the first integer is not greater than 8

In one embodiment, the first integer is equal to 1.

In one embodiment, the first integer is equal to 2.

In one embodiment, if the first operation is not returning to the source cell, reset the first counter.

In one embodiment, if the first operation is re-configured, reset the first counter.

In one embodiment, if a network triggered handover is executed, reset the first counter.

In one embodiment, the resetting the first counter refers to set a value of the first counter to 0.

In one embodiment, the resetting the first counter refers to set the first counter to an initial value.

### Embodiment 11C

Embodiment 11C illustrates a structure block diagram of a processor in a first node according to one embodiment of the present application, as shown in FIG. 11. In FIG. 11, a processor 1100 in a first node comprises a first receiver 1101, a first transceiver 1102 and a first transmitter 1103.

The first receiver 1101 receives a first signaling, and the first signaling indicates a configuration of a first cell; executes a first handover from a source cell to the first cell; determines first handover failure;
the first transceiver 1102, as a response to the behavior of determining first handover failure, executes a first operation;

In embodiment 11C, the behavior of executing a first handover from a source cell to the first cell comprises applying the configuration of the first cell; the first operation is a candidate operation in a first candidate operation set, and the first candidate operation set comprises at least two candidate operations of returning to the source cell and executing a second handover; the first operation is related to at least whether the first node is configured with at least one conditional reconfiguration candidate cell; when the first node is not configured with a conditional reconfiguration candidate cell, the first operation is returning to the source cell.

In one embodiment, the first node is configured with at least one conditional reconfiguration candidate cell; the first operation is related to whether there exists at least one cell in which an execution condition is satisfied in the at least one conditional reconfiguration candidate cell during the first handover; when there does not exist a cell in which an execution condition is satisfied in the at least one conditional reconfiguration candidate cell during the first handover, the first operation is returning to the source cell.

In one embodiment, the first node is configured with at least one conditional reconfiguration candidate cell, there exists at least one cell in which an execution condition is satisfied in the at least one conditional reconfiguration candidate cell in the first handover period, and the first operation is related to whether the at least one cell in which an execution condition is satisfied comprises at least one target cell not used for the first node performing handover within a first time window; when the at least one cell in which an execution condition is satisfied does not comprise a target cell not used for the first node performing handover within a first time window, the first operation is returning to the source cell; when the at least one cell in which an execution condition is satisfied comprises a target cell not used for the first node performing handover within a first time window, the first operation is executing the second handover.

In one embodiment, the first node is configured with at least one conditional reconfiguration candidate cell; the first operation is related to whether there exists at least one cell in which a cell selection condition is satisfied in the at least one condition reconfiguration candidate cell while a first timer is running; when there does not exist a cell in which a cell selection condition is satisfied in the at least one conditional reconfiguration candidate cell while the first timer is running, the first operation is returning to the source cell; an expiration of the first timer is used to determine that there does not exist a cell in which a cell selection condition is satisfied.

In one embodiment, the first node is configured with at least one conditional reconfiguration candidate cell, there exists at least one cell in which a cell selection condition is satisfied in the at least one conditional reconfiguration candidate cell while a first timer is running, and the first operation is related to whether the at least one cell in which a cell selection condition is satisfied comprises at least one target cell not used for the first node performing handover within a first time window; when the at least one cell in which a cell selection condition is satisfied does not comprise a target cell not used for the first node performing handover within a first time window, the first operation is returning to the source cell; when the at least one cell in which a cell selection condition is satisfied comprises a target cell not used for the first node performing handover within a first time window, the first operation is executing the second handover.

In one embodiment, the first node is configured with at least one conditional reconfiguration candidate cell, the first operation is related to whether a first counter reaches a first integer; when the first counter does not reach the first integer, the first operation is returning to the source cell; if the first operation is returning to the source cell, the first counter is incremented by 1.

In one embodiment, a first bearer is configured, and the first bearer is a DAPS bearer for the first cell.

In one embodiment, no radio link failure occurs in the source cell during the first handover.

In one embodiment, the first receiver 1101, accompanying the configuration of the first cell, starts a second timer; herein, an expiration of the second timer is used to determine the first handover failure.

In one embodiment, the first receiver 1101 determines second handover failure; as a response to the behavior of determining second handover failure, returning to the source cell.

In one embodiment, the first receiver 1101 receives a second signaling, and the second signaling indicates a configuration of each cell in the at least one conditional reconfiguration candidate cell; the first transmitter 1103 transmits a third signaling, the third signaling is triggered by the second signaling.

In one embodiment, the first transceiver 1102 receives at least one of MIB, PBCH, Msg2, Msg4, or MsgB; the first transceiver 1102 transmits at least one of Msg1, Msg3, MsgA, an RRCReconfigurionComplete message, or an RRCConnectionReconfigurionComplete message.

In one embodiment, the first receiver 1101 comprises the antenna 452, the receiver 454, the multi-antenna receiving processor 458, the receiving processor 456, the controller/processor 459, the memory 460 and the data source 467 in FIG. 4 of the present application.

In one embodiment, the first receiver 1101 comprises the antenna 452, the receiver 454, the multi-antenna receiving processor 458 and the receiving processor 456 in FIG. 4 of the present application.

In one embodiment, the first receiver 1101 comprises the antenna 452, the receiver 454 and the receiving processor 456 in FIG. 4 of the present application.

In one embodiment, the first transceiver 1102 comprises the antenna 452, the transmitter 454, the multi-antenna transmitting processor 457, the transmitting processor 468, the receiver 454, the multi-antenna receiving processor 458, the receiving processor 456, the controller/processor 459, the memory 460 and the data source 467 in FIG. 4 of the present application.

In one embodiment, the first transceiver 1102 comprises the antenna 452, the transmitter 454, the multi-antenna transmitting processor 457, the transmitting processor 468, the receiver 454, the multi-antenna receiving processor 458 and the receiving processor 456 in FIG. 4 of the present application.

In one embodiment, the first transceiver 1102 comprises the antenna 452, the transmitter 454, the transmitting processor 468, the receiver 454 and the receiving processor 456 in FIG. 4 of the present application.

In one embodiment, the first transmitter 1103 comprises the antenna 452, the transmitter 454, the multi-antenna transmitting processor 457, the transmitting processor 468, the controller/processor 459, the memory 460, and the data source 467 in FIG. 4 of the present application.

In one embodiment, the first transmitter 1103 comprises the antenna 452, the transmitter 454, the multi-antenna transmitting processor 457 and the transmitting processor 468 in FIG. 4 of the present application.

In one embodiment, the first transmitter 1103 comprises the antenna 452, the transmitter 454 and the transmitting processor 468 in FIG. 4 of the present application.

### Embodiment 12C

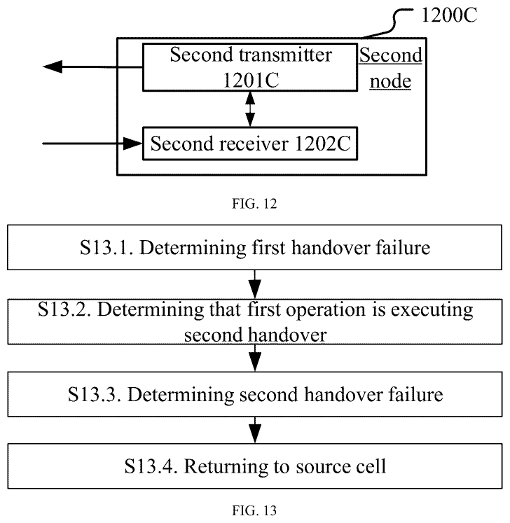

Embodiment 12C illustrates a structure block diagram of a processor in a second node according to one embodiment of the present application, as shown in FIG. 12. In FIG. 12, a processor 1200C in a second node comprises a second transmitter 1201C and a second receiver 1202C.

The second transmitter 1201C transmits a first signaling, and the first signaling indicates a configuration of a first cell;

In embodiment 12C, a first handover from a source cell to the first cell is executed; first handover failure is determined; as a response to the first handover failure being determined, a first operation is executed; the behavior of executing a first handover from a source cell to the first cell comprises applying the configuration of the first cell; the first operation is a candidate operation in a first candidate operation set, and the first candidate operation set comprises at least two candidate operations of returning to the source cell and executing a second handover; the first operation is related to at least whether the first node is configured with at least one conditional reconfiguration candidate cell; when the first node is not configured with a conditional reconfiguration candidate cell, the first operation is returning to the source cell.

In one embodiment, a receiver of the first signaling is configured with at least one conditional reconfiguration candidate cell; the first operation is related to whether there exists at least one cell in which an execution condition is satisfied in the at least one conditional reconfiguration candidate cell during the first handover; when there does not exist a cell in which an execution condition is satisfied in the at least one conditional reconfiguration candidate cell during the first handover, the first operation is returning to the source cell.

In one embodiment, a receiver of the first signaling is configured with at least one conditional reconfiguration candidate cell, there exists at least one cell in which an execution condition is satisfied in the at least one conditional reconfiguration candidate cell during the first handover, and the first operation is related to whether the at least one cell in which an execution condition is satisfied comprises at least one target cell not used for a receiver of the first signaling performing handover within a first time window; when the at least one cell in which an execution condition is satisfied does not comprise a target cell not used for a receiver of the first signaling for performing handover within a first time window, the first operation is returning to the source cell; when the at least one cell in which an execution condition is satisfied comprises a target cell not used for a receiver of the first signaling for performing handover within a first time window, the first operation is executing the second handover.

In one embodiment, a receiver of the first signaling is configured with at least one conditional reconfiguration candidate cell; the first operation is related to whether there exists at least one cell in which a cell selection condition is satisfied in the at least one condition reconfiguration candidate cell while a first timer is running; when there does not exist a cell in which a cell selection condition is satisfied in the at least one conditional reconfiguration candidate cell while the first timer is running, the first operation is returning to the source cell; an expiration of the first timer is used to determine that there does not exist a cell in which a cell selection condition is satisfied.

In one embodiment, a receiver of the first signaling is configured with at least one conditional reconfiguration candidate cell, there exists at least one cell in which a cell selection condition is satisfied in the at least one conditional reconfiguration candidate cell while a first timer is running, and the first operation is related to whether the at least one cell in which a cell selection condition is satisfied comprises at least one target cell not used for a receiver of the first signaling for performing handover within a first time window; when the at least one cell in which a cell selection condition is satisfied does not comprise a target cell not used for a receiver of the first signaling for performing handover within a first time window, the first operation is returning to the source cell; when the at least one cell in which a cell selection condition is satisfied comprises a target cell not used for a receiver of the first signaling for performing handover within a first time window, the first operation is executing the second handover.

In one embodiment, a receiver of the first signaling is configured with at least one conditional reconfiguration candidate cell, the first operation is related to whether a first counter reaches a first integer; when the first counter does not reach the first integer, the first operation is returning to the source cell; if the first operation is returning to the source cell, the first counter is incremented by 1.

In one embodiment, a first bearer is configured, and the first bearer is a DAPS bearer for the first cell.

In one embodiment, no radio link failure occurs in the source cell during the first handover.

In one embodiment, accompanying the configuration of the first cell is applied, a second timer is started; an expiration of the second timer is used to determine the first handover failure.

In one embodiment, as a response to the behavior of determining second handover failure, returning to the source cell is executed.

In one embodiment, the second transmitter 1201C transmits a second signaling, and the second signaling indicates a configuration of each cell in the at least one conditional reconfiguration candidate cell; the second receiver 1202C receives a third signaling, and the third signaling is triggered by the second signaling.

In one embodiment, the second transmitter 1201C transmits at least one of MIB, PBCH, Msg2, Msg4, or MsgB; the second receiver 1202C receives at least one of Msg1, Msg3, MsgA, an RRCReconfigurionComplete message, or an RRCConnectionReconfigurionComplete message.

In one embodiment, the second transmitter 1201C comprises the antenna 420, the transmitter 418, the multi-antenna transmitting processor 471, the transmitting processor 416, the controller/processor 475 and the memory 476 in FIG. 4 of the present application.

In one embodiment, the second transmitter 1201C comprises the antenna 420, the transmitter 418, the multi-antenna transmitting processor 471 and the transmitting processor 416 in FIG. 4 of the present application.

In one embodiment, the second transmitter 1201C comprises the antenna 420, the transmitter 418 and the transmitting processor 416 in FIG. 4 of the present application.

In one embodiment, the second receiver 1202C comprises the antenna 420, the receiver 418, the multi-antenna receiving processor 472, the receiving processor 470, the controller/processor 475 and the memory 476 in FIG. 4 of the present application.

In one embodiment, the second receiver 1202C comprises the antenna 420, the receiver 418, the multi-antenna receiving processor 472 and the receiving processor 470 in FIG. 4 of the present application.

In one embodiment, the second receiver 1202C comprises the antenna 420, the receiver 418 and the receiving processor 470 in FIG. 4 of the present application.

### Embodiment 13C

Embodiment 13C illustrates a flowchart of second handover failure being used to determine returning to a source cell according to one embodiment of the present application, as shown in FIG. 13. It is particularly underlined that the order illustrated in the embodiment does not put constraints over sequences of signal transmissions and implementations.

In Embodiment 13C, in step S13.1, determine first handover failure; in step S13.2, as a response to the behavior of determining first handover failure, determine that the first operation is to execute the second handover; in step S13. 3, determine second handover failure; in step S13. 4, as a response to the behavior of determining second handover failure, return to the source cell.

In one embodiment, accompanying the initiation of the second handover, start timer T304; an expiration of the timer T304 is used to determine the second handover failure.

In one embodiment, a random access procedure failure on the second cell is used to determine the second handover failure.

In one embodiment, downlink not synchronized to the second cell is used to determine the second handover failure.

In one embodiment, an MIB or PBCH of the second cell not received is used to determine the second handover failure.

In one embodiment, a configuration of the source cell is not released within a time interval between a determination of the first handover failure and a determination of the second handover failure.

In one embodiment, within a time interval between a determination of the first handover failure and a determination of the second handover failure, maintain a configuration of the source cell.

In one embodiment, within a time interval between a determination of the first handover failure and a determination of the second handover failure, a configuration of the source cell is suspended.

In one embodiment, a second bearer is configured, and the second bearer is a DAPS bearer for the second cell.

In one embodiment, no radio link failure occurs in the source cell during the second handover period.

In one embodiment, a second bearer is configured, and the second bearer is a DAPS bearer for the second cell, and no radio link failure occurs in the source cell in the second handover period.

In one embodiment, if the second bearer is configured, the behavior of executing a second handover also comprises at least one of the following behaviors:
creating a MAC entity of a cell group to which the second cell belongs with a configuration as a MAC entity in a cell group to which the source cell belongs;
for the second bearer, establishing an RLC entity in a cell group to which the second cell belongs with a same configuration as an RLC entity in a cell group to which the source cell belongs, and for the second bearer, establishing a logical channel in a cell group to which the second cell belongs with a same configuration as a logical channel in a cell group to which the source cell belongs;
for each SRB, establishing an RLC entity in a cell group to which the second cell belongs with a same configuration as an RLC entity in a cell group to which the source cell belongs, and for the second bearer, establishing a logical channel in a cell group to which the second cell belongs with a same configuration as a logical channel in a cell group to which the source cell belongs;
suspending an SRB of a cell group to which the source cell belongs.

In one embodiment, as a response to the behavior of determining first handover failure, if the first node is configured with a conditional reconfiguration candidate cell, and the second bearer is configured, all or part of the following behaviors are not executed:
resetting a MAC for the source cell and releasing a MAC configuration for the source cell;
for the first bearer, releasing an RLC entity and a related logical channel for the source cell;
for the first bearer, reconfiguring a DAPS entity to release a DAPS;
for each SRB, releasing a PDCP entity for the source cell;
for each SRB, releasing an RLC entity and a related logical channel for the source cell;
releasing a physical channel configuration for the source cell;
if a key in the source cell is configured, discarding a key in the source cell.

In one embodiment, if a second bearer is not configured, or radio link failure occurs in the source cell in the second handover period, as a response to the behavior of determining second handover failure, enter into RRC_IDLD state.

In one embodiment, if a second bearer is not configured, the second bearer is a DAPS bearer for the second cell, or radio link failure occurs in the source cell in the second handover period, as a response to the behavior of determining second handover failure, execute an RRC connection re-establishment procedure.

In one subembodiment of the embodiment, during the procedure of the RRC connection re-establishment, an RRCReestablishmentRequest message or an RRCConnectionReestablishmentRequest message is transmitted.

In one subembodiment of the embodiment, during the procedure of the RRC connection re-establishment, an RRCReestablishment message or an RRCConnectionReestablishment message is received.

In one subembodiment of the embodiment, during the procedure of the RRC connection re-establishment, an RRCReestablishmentComplete message or an RRCConnectionReesablishmentComplete message is transmitted.

In one subembodiment of the embodiment, during the procedure of the RRC connection re-establishment, an RRCReconfiguration message or an RRCConnectionReconfiguration message is received.

In one subembodiment of the embodiment, during the procedure of the RRC connection re-establishment, an RRCReconfigurementComplete message or an RRCConnectionReconfigurementComplete message is transmitted.

In one embodiment, the second bearer and the first bearer correspond to a same DRB.

In one embodiment, the second bearer and the first bearer correspond to different DRBs.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The user equipment, terminal and UE include but are not limited to Unmanned Aerial Vehicles (UAVs), communication modules on UAVs, tele-controlled aircrafts, aircrafts, diminutive airplanes, mobile phones, tablet computers, notebooks, vehicle-mounted communication equipment, wireless sensors, network cards, Internet of Things (IoT) terminals, RFID terminals, NB-IOT terminals, Machine Type Communication (MTC) terminals, enhanced MTC (eMTC) terminals, data card, network cards, vehicle-mounted communication equipment, low-cost mobile phones, low-cost tablets and other wireless communication devices. The UE and terminal in the present application include but not limited to unmanned aerial vehicles, communication modules on unmanned aerial vehicles, tele-controlled aircrafts, aircrafts, diminutive airplanes, mobile phones, tablet computers, notebooks, vehicle-mounted communication equipment, wireless sensor, network cards, terminals for Internet of Things, RFID terminals, NB-IOT terminals, Machine

Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, gNB (NR node B), Transmitter Receiver Point (TRP), and other radio communication equipment.

The above are merely the preferred embodiments of the present application and are not intended to limit the scope of protection of the present application. Any modification, equivalent substitute and improvement made within the spirit and principle of the present application are intended to be included within the scope of protection of the present application.

What is claimed is:

1. A first node for wireless communications, comprising:
a first receiver, receiving a first signaling, the first signaling indicating a configuration of a first cell; executing a first handover from a source cell to the first cell; determining first handover failure; and
a first transceiver, as a response to the behavior of determining first handover failure, executing a first operation;
wherein the behavior of executing a first handover from a source cell to the first cell comprises applying the configuration of the first cell; the first operation is a candidate operation in a first candidate operation set, and the first candidate operation set comprises at least two candidate operations of returning to the source cell and executing a second handover; the first operation is related to at least whether the first node is configured with at least one conditional reconfiguration candidate cell; when the first node is not configured with a conditional reconfiguration candidate cell, the first operation is returning to the source cell.

2. The first node according to claim 1, wherein the first node is configured with at least one conditional reconfiguration candidate cell; the first operation is related to whether there exists at least one cell in which an execution condition is satisfied in the at least one conditional reconfiguration candidate cell during the first handover; when there does not exist a cell in which an execution condition is satisfied in the at least one conditional reconfiguration candidate cell during the first handover, the first operation is returning to the source cell.

3. The first node according to claim 1, wherein the first node is configured with at least one conditional reconfiguration candidate cell, there exists at least one cell in which an execution condition is satisfied in the at least one conditional reconfiguration candidate cell during the first handover, and the first operation is related to whether the at least one cell in which an execution condition is satisfied comprises at least one target cell not used for the first node performing handover within a first time window; when the at least one cell in which an execution condition is satisfied does not comprise a target cell not used for the first node performing handover within a first time window, the first operation is returning to the source cell; when the at least one cell in which an execution condition is satisfied comprises a target cell not used for the first node performing handover within a first time window, the first operation is executing the second handover.

4. The first node according to claim 1, wherein the first node is configured with at least one conditional reconfiguration candidate cell; the first operation is related to whether there exists at least one cell in which a cell selection condition is satisfied in the at least one condition reconfiguration candidate cell while a first timer is running; when there does not exist a cell in which a cell selection condition is satisfied in the at least one conditional reconfiguration candidate cell while the first timer is running, the first operation is returning to the source cell; an expiration of the first timer is used to determine that there does not exist a cell in which a cell selection condition is satisfied.

5. The first node according to claim 1, wherein the first node is configured with at least one conditional reconfiguration candidate cell, there exists at least one cell in which a cell selection condition is satisfied in the at least one conditional reconfiguration candidate cell while a first timer is running, and the first operation is related to whether the at least one cell in which a cell selection condition is satisfied comprises at least one target cell not used for the first node performing handover within a first time window; when the at least one cell in which a cell selection condition is satisfied does not comprise a target cell not used for the first node performing handover within a first time window, the first operation is returning to the source cell; when the at least one cell in which a cell selection condition is satisfied comprises a target cell not used for the first node performing handover within a first time window, the first operation is executing the second handover.

6. The first node according to claim 1, wherein the first node is configured with at least one conditional reconfiguration candidate cell, and the first operation is related to whether a first counter reaches a first integer; when the first counter does not reach the first integer, the first operation is returning to the source cell; if the first operation is returning to the source cell, the first counter is incremented by 1.

7. The first node according to claim 1, wherein a first bearer is configured, and the first bearer is a DAPS bearer for the first cell.

8. The first node according to claim 7, wherein no radio link failure occurs in the source cell during the first handover.

9. A second node for wireless communications, comprising:
a second transmitter, transmitting a first signaling, the first signaling indicating a configuration of a first cell;
wherein a first handover from a source cell to the first cell is executed; first handover failure is determined; as a response to the first handover failure being determined, a first operation is executed; the behavior of executing a first handover from a source cell to the first cell comprises applying the configuration of the first cell; the first operation is a candidate operation in a first candidate operation set, and the first candidate operation set comprises at least two candidate operations of returning to the source cell and executing a second handover; the first operation is related to at least whether a receiver of the first signaling is configured with at least one conditional reconfiguration candidate cell; when a receiver of the first signaling is not configured with a conditional reconfiguration candidate cell, the first operation is returning to the source cell.

10. The second node according to claim 9, wherein the first node is configured with at least one conditional reconfiguration candidate cell; the first operation is related to whether there exists at least one cell in which an execution condition is satisfied in the at least one conditional reconfiguration candidate cell during the first handover; when there does not exist a cell in which an execution condition is satisfied in the at least one conditional reconfiguration candidate cell during the first handover, the first operation is returning to the source cell.

11. The second node according to claim 9, wherein the first node is configured with at least one conditional reconfiguration candidate cell, there exists at least one cell in which an execution condition is satisfied in the at least one conditional reconfiguration candidate cell during the first handover, and the first operation is related to whether the at least one cell in which an execution condition is satisfied comprises at least one target cell not used for the first node performing handover within a first time window; when the at least one cell in which an execution condition is satisfied does not comprise a target cell not used for the first node performing handover within a first time window, the first operation is returning to the source cell; when the at least one cell in which an execution condition is satisfied comprises a target cell not used for the first node performing handover within a first time window, the first operation is executing the second handover.

12. The second node according to claim 9, wherein the first node is configured with at least one conditional reconfiguration candidate cell; the first operation is related to whether there exists at least one cell in which a cell selection condition is satisfied in the at least one condition reconfiguration candidate cell while a first timer is running; when there does not exist a cell in which a cell selection condition is satisfied in the at least one conditional reconfiguration candidate cell while a first timer is running, the first operation is returning to the source cell; an expiration of the first timer is used to determine that there does not exist a cell in which a cell selection condition is satisfied.

13. The second node according to claim 9, wherein the first node is configured with at least one conditional reconfiguration candidate cell, there exists at least one cell in which a cell selection condition is satisfied in the at least one conditional reconfiguration candidate cell while a first timer is running, and the first operation is related to whether the at least one cell in which a cell selection condition is satisfied comprises at least one target cell not used for the first node performing handover within a first time window; when the at least one cell in which a cell selection condition is satisfied does not comprise a target cell not used for the first node performing handover within a first time window, the first operation is returning to the source cell; when the at least one cell in which a cell selection condition is satisfied comprises a target cell not used for the first node performing handover within a first time window, the first operation is executing the second handover.

14. The second node according to claim 9, wherein the first node is configured with at least one conditional reconfiguration candidate cell, and the first operation is related to whether a first counter reaches a first integer; when the first counter does not reach the first integer, the first operation is returning to the source cell; if the first operation is returning to the source cell, the first counter is incremented by 1.

15. The second node according to claim 9, wherein a first bearer is configured, and the first bearer is a DAPS bearer for the first cell.

16. The second node according to claim 15, wherein no radio link failure occurs in the source cell during the first handover.

17. A method in a first node for wireless communications, comprising:
receiving a first signaling, the first signaling indicating a configuration of a first cell; executing a first handover from a source cell to the first cell; determining first handover failure; and
as a response to the behavior of determining first handover failure, executing a first operation;
wherein the behavior of executing a first handover from a source cell to the first cell comprises applying the configuration of the first cell; the first operation is a candidate operation in a first candidate operation set, and the first candidate operation set comprises at least two candidate operations of returning to the source cell and executing a second handover; the first operation is related to at least whether the first node is configured with at least one conditional reconfiguration candidate cell; when the first node is not configured with a conditional reconfiguration candidate cell, the first operation is returning to the source cell.

18. The first node according to claim 17, wherein the first node is configured with at least one conditional reconfiguration candidate cell; the first operation is related to whether there exists at least one cell in which an execution condition is satisfied in the at least one conditional reconfiguration candidate cell during the first handover; when there does not exist a cell in which an execution condition is satisfied in the at least one conditional reconfiguration candidate cell during the first handover, the first operation is returning to the source cell.

19. The first node according to claim 17, wherein the first node is configured with at least one conditional reconfiguration candidate cell, there exists at least one cell in which an execution condition is satisfied in the at least one conditional reconfiguration candidate cell during the first handover, and the first operation is related to whether the at least one cell in which an execution condition is satisfied comprises at least one target cell not used for the first node performing handover within a first time window; when the at least one cell in which an execution condition is satisfied does not comprise a target cell not used for the first node performing handover within a first time window, the first operation is returning to the source cell; when the at least one cell in which an execution condition is satisfied comprises a target cell not used for the first node performing handover within a first time window, the first operation is executing the second handover.

20. The first node according to claim 17, wherein the first node is configured with at least one conditional reconfiguration candidate cell; the first operation is related to whether there exists at least one cell in which a cell selection condition is satisfied in the at least one condition reconfiguration candidate cell while a first timer is running; when there does not exist a cell in which a cell selection condition is satisfied in the at least one conditional reconfiguration candidate cell while the first timer is running, the first operation is returning to the source cell; an expiration of the first timer is used to determine that there does not exist a cell in which a cell selection condition is satisfied.
